(19) United States
(12) Patent Application Publication
(10) Pub. No.: US 2026/0039432 A1
(43) Pub. Date: Feb. 5, 2026

(54) METHODS, ARCHITECTURES, APPARATUSES AND SYSTEMS FOR NEAR-FIELD REGION DETECTION AND REPORTING

(71) Applicant: InterDigital Patent Holdings, Inc., Wilmington, DE (US)

(72) Inventors: Allan Yingming Tsai, Boonton, NJ (US); Afshin Haghighat, Ile-Bizard (CA); Patrick Svedman, Stockholm (SE); Ravikumar Pragada, Warrington, PA (US); Yifan Li, Conshohocken, PA (US); Salah Elhoushy, LaSalle (CA); Chia-Hung Wei, Chesterbrook, PA (US); Loic Canonne-Velasquez, Dorval (CA); Virgil Comsa, Montreal (CA); Moon IL Lee, Melville, NY (US); Jonghyun Park, Syosset, NY (US)

(21) Appl. No.: 18/790,527

(22) Filed: Jul. 31, 2024

(51) Int. Cl. H04L 5/00

(52) U.S. Cl. CPC H04L 5/005; H04L 5/0087

(57) ABSTRACT

Procedures, methods, architectures, apparatuses, systems, devices, and computer program products for near-field (NF) region detection. It may be beneficial if a wireless transmit-receive unit (WTRU) and the network are aware of whether the WTRU is within a NF region or not. A WTRU may be configured with a primary (P-RS) and a secondary (S-RS) set of resources. The WTRU performs measurements on each pair of associated RS resources selected from the P-RS and S-RS resource sets. Based on measurement results, the WTRU selects one or more RS groups that include a S-RS and an associated P-RS, and determines whether a pre-defined measurement condition is fulfilled. Based on the determined state for the selected RS groups, the WTRU determines to report an NF detection to the network, such as to enable location division multiple access and beam focusing which may enable enhanced spectrum efficiency.

### INCORPORATION BY REFERENCE

The following document is incorporated by reference in its entirety: 3GPP TS 38.321 v17.2.0 (Release 17).

### BACKGROUND

The present disclosure is generally directed to the fields of communications, software and encoding, including, for example, to methods, architectures, apparatuses, systems related to near-field radio communications in wireless networks.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates location-based multiple access in an NF focus region and classical (legacy) spatial direction multiple access in an FF region;

FIG. 3 shows different WTRUs are in different NF regions;

FIG. 4 is an example configuration of two secondary RS resource sets with a primary RS and configured QCL relations;

FIG. 5 is an exemplary configuration of one primary RS resource set, one secondary RS resource set and the corresponding QCL associations relations between primary RS resource set and secondary resource set;

FIG. 6 shows example groups from two RS (e.g., CSI) resource sets with corresponding QCL associations relations;

FIG. 7 shows exemplary RS groups from primary RS resource set and a secondary resource set with the corresponding QCL associations relations;

FIG. 8 shows two NF regions from different TRPs (two TRPs) are associated with two different RS groups;

FIG. 9 is a flow chart of an exemplary NF/FF detection/determination method for an RS group;

FIG. 10 is a table showing examples of determination of NF/FF region based on primary RS (P-RS) and secondary RS (S-RS);

FIG. 11 shows RSRP of FF beams and NF beams plotted against distance;

FIG. 12 shows NF region determination when explicit information is signaled in configuration information;

FIG. 13 shows periodic NF region detection/determination and reporting, FIG. 13 (a) shows periodic NF/FF region detection and reporting, and FIG. 13 (b) shows aperiodic NF/FF region detection and reporting, wherein a WTRU may be configured with a detection window for performing NF/FF region detection;

FIG. 14 is a sequence chart of a method for NF/FF region detection; and

FIG. 15 is a flow chart of a method according to an embodiment.

### DETAILED DESCRIPTION

Abbreviations and acronyms

| | |
|---|---|
| 5GS | 5G System |
| A/N | ACK/NACK |
| ACK | Acknowledge |
| ARQ | Automatic Repeat Request |
| A-RS/S-RS | Secondary RS (Auxiliary RS) |
| B-RS/P-RS | Primary RS (Base-RS) |
| CH | Channel |
| CRI | CSI-RS Resource Indicator |
| CSI | Channel State Information |
| CSI-RS | CSI-Reference Signal |
| DCI | Downlink Control Information |
| dB | Decibel |
| dBm | Decibel-milliwatts |
| DL | Downlink |
| DM | Demodulation |
| DM(−)RS | DM Reference Signal |
| EM | Electromagnetic |
| FF | Far Field |
| GPS | Global Positioning System |
| HARQ | Hybrid ARQ |
| ID | Identifier |
| L1, L2, L3 | Layer-1, Layer-2, Layer-3 |
| LCH | Logical Channel |
| LDMA | Location Division Multiple Access |
| LTM | Layer-2 Mobility |
| NACK | Non-Acknowledge |
| NF | Near Field |
| NR | New Radio |
| NW | Network |
| MAC | Medium Access Control |
| MAC-CE | MAC Control Element |
| MIMO | Multiple Input Multiple Output |
| ms | milliseconds |
| OFDM | Orthogonal frequency-division multiplexing |
| PBCH | Physical Broadcast Channel |
| PDCCH | Physical DL Control Channel |
| PDU | Protocol Data Unit |
| PDSCH | Physical DL Shared Channel |
| PMI | Precoding Matrix Indicator |
| PRACH | Physical Random-Access Channel |
| PUCCH | Physical UL Control Channel |
| PUSCH | Physical UL Shared Channel |
| QCL | Quasi-Colocation |
| QCL-D | QCL type D |
| QCLed | Quasi-Colocated |
| RACH | Random Access Channel |
| RAT | Radio Access Technology |
| RF | Radio Frequency |
| RI | Rank Indicator |
| RRC | Radio Resource Control |
| RS | Reference Signal(s) |
| RSRP | Reference Signal Received Power |
| RSRQ | Reference Signal Received Quality |
| Rx | Receive(r) |
| SCG | Secondary Cell Group |
| SIB | System Information Block |
| SINR | Signal-to-Interference and Noise Ratio |
| SN | Secondary Node |
| SR | Scheduling Request |
| SS | Synchronization Signal |
| SSB | SS Block |
| TCI | Transmission Synchronization Indicator |
| TRP | Transmission/Reception Point |
| Tx | Transmit(ter) |
| UCI | UL Control Information |
| UE | User Equipment (see WTRU) |
| UL | Uplink |
| ULA | Uniform Linear Array |
| WTRU | Wireless Transmit-Receive Unit (see UE) |

### Common Terminology

### Rayleigh Distance

The Rayleigh distance, also known as the Fraunhofer distance, marks the boundary between the near-field and far-field regions of an electromagnetic field. It is crucial in antenna array applications and electromagnetic wave propagation. The Rayleigh distance is calculated using the size of the antenna array (aperture) and the carrier frequency, and is proportional to the square of the array aperture and the carrier frequency. The formula is:

$${D}_{R} = \frac{2 {D}^{2}}{λ} ,$$

where D_{R} is the Rayleigh distance, D is the diameter of the antenna array (array aperture), and lambda is the wavelength of the carrier signal. Beyond this distance, electromagnetic fields can be approximated by planar waves, simplifying wave propagation and antenna behavior analysis. This concept is increasingly important with the advent of 6G technology, which uses extremely large aperture arrays (ELAAs) and operates at millimeter-wave and terahertz frequencies. Understanding the Rayleigh distance is essential for designing efficient wireless communication systems to meet the demands of emerging applications.

### Reference Signal(s) (RS)

A Reference Signal is a signal that occupies specific resource elements (REs) within the DL or UL time-frequency grid.

The term channel state information reference signal (CSI-RS) may for example refer to one or more CSI-RS resource(s) or one or more antenna ports of a CSI-RS resource. It may also more generally refer to a downlink (DL) RS, such as a synchronization signal (SS) and physical broadcast channel (PBCH) block (SS/PBCH block or SSB). Note that DL RS may for example refer to CSI-RS, SSB, physical DL control channel (PDCCH) demodulation RS (DM-RS), physical downlink shared channel (PDSCH) DMRS, etc.

The term sounding reference signal (SRS) may for example refer to one or more SRS resource(s) or one or more antenna ports of an SRS resource. It may also more generally refer to an uplink (UL) RS. UL RS may refer to SRS, physical uplink control channel (PUCCH) DM-RS, physical uplink shared channel (PUSCH) DM-RS, physical random-access channel (PRACH), etc.

### Reference Signal (RS) Resource

An RS resource is for example time (over how many OFDM symbols an RS will span), frequency (over how many resource blocks and density an RS will span), or grid where RS will be allocated.

### Beam

The term beam may for example refer to a spatial domain filter, e.g., a WTRU spatial domain filter. For instance, a DL receive (Rx) beam may refer to a spatial domain receive filter, while an UL transmit (Tx) beam may refer to a spatial domain transmit filter.

A beam may correspond to a precoder, e.g., a vector, that maps information or reference symbols to transmitter chains. A beam may correspond to a combiner or receiver filter, e.g., a vector that maps signals from receiver chains to information or reference symbols. A beam may correspond to a set of phases and/or amplitude shifts applied to a radio frequency (RF) signal prior to signal transmission from an antenna or after signal reception from an antenna.

A beam corresponding to a DL RS, e.g., CSI-RS, may refer to a DL Rx beam a WTRU used to receive the DL RS. A beam corresponding to an UL RS or UL channel may refer to an UL Tx beam a WTRU uses to transmit the UL RS/channel.

### QCL Relation

A QCL relation is defined between an antenna port of a (source) RS (e.g., a CSI-RS or SSB) and an antenna port of a (target) RS (e.g., a CSI-RS or DM-RS). Two antenna ports are said to be QCL if properties of the channel over which a symbol on one antenna port is conveyed can be inferred from the channel over which a symbol on the other antenna port is conveyed. In other words, QCL relation indicates that two transmitting signals from two different antenna ports experience radio channels having common properties e.g. spatial Rx parameter. The WTRU can use the QCL indication that provides an assumption of QCL to determine the spatial Rx parameter between two RSs when QCL information is indicated with QCL Type D.

### Spatial Relation

A spatial relation can be configured to hold between a received DL RS and a transmitted UL signal, whereas a QCL relation is always between two transmitted DL RS signals (observed at a receiver). Hence, the spatial relation framework provides a method for the network to steer the UL transmission so that it improves the reception quality at a NW/gNB.

### Primary/Base RS (P-RS/B-RS) and Secondary/Auxiliary RS (S-RS/A-RS)

For NF/FF region detection, multiple RSs can be configured for a WTRU. The configured RS can be categorized as the primary RS (B-RS) and secondary RS (A-RS). If a RS is configured/signaled as a B-RS, then the WTRU can use this RS for the assessment of NF/FF region detection. In addition, some secondary RS can be configured as A-RS and WTRU can use both B-RS and A-RS for NF/FF region detection. The B-RS and A-RS can be further configured with QCL relation/information, e.g., the QCL source RS of an A-RS may be the associated B-RS.

### Primary RS Resource Set and Secondary RS Resource Set

A plurality of B-RS can be configured into an RS resource set, and we define this set as a primary RS resource set. Similarly, a plurality of A-RS can be configured into an RS resource set, and we define this kind of set as a secondary RS resource set.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

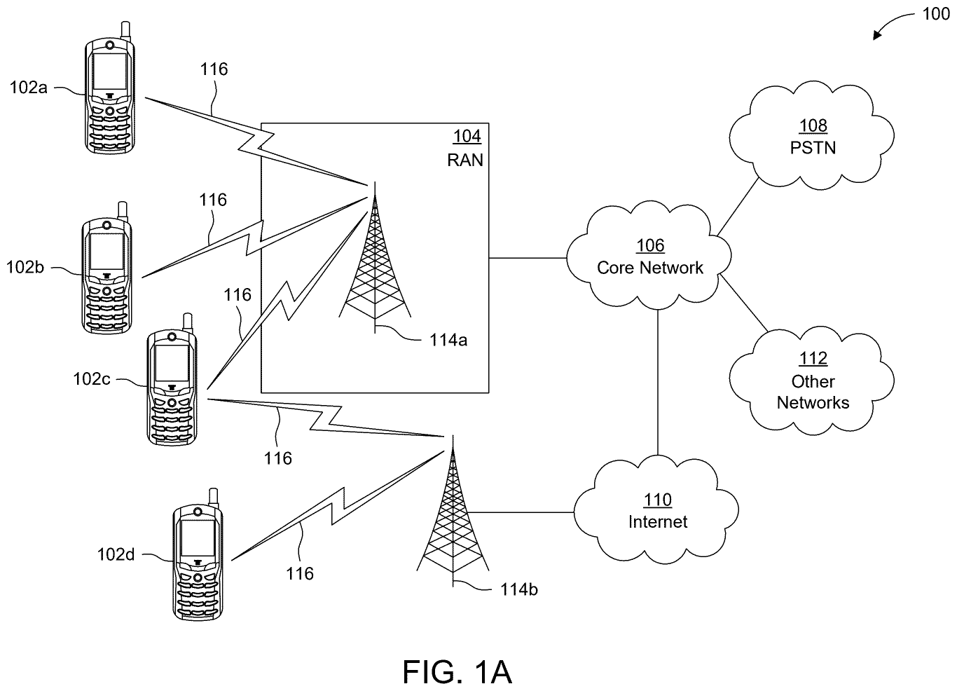

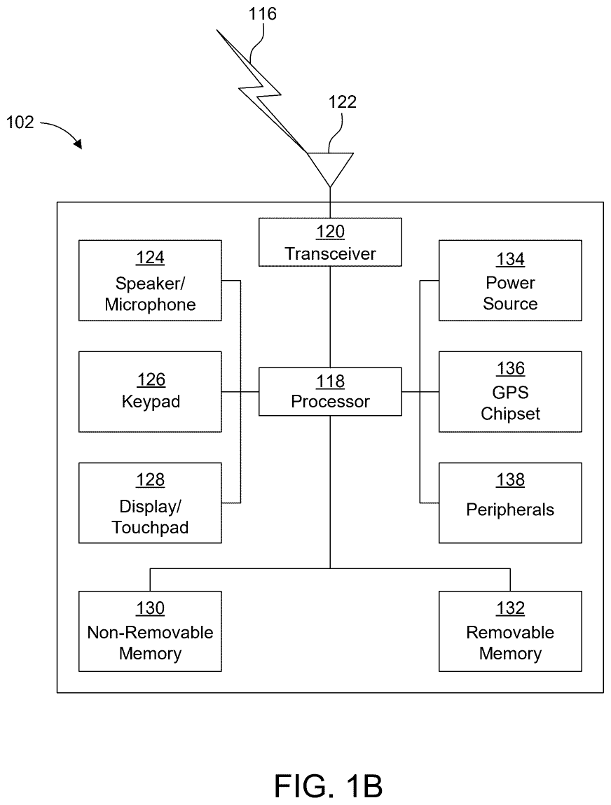

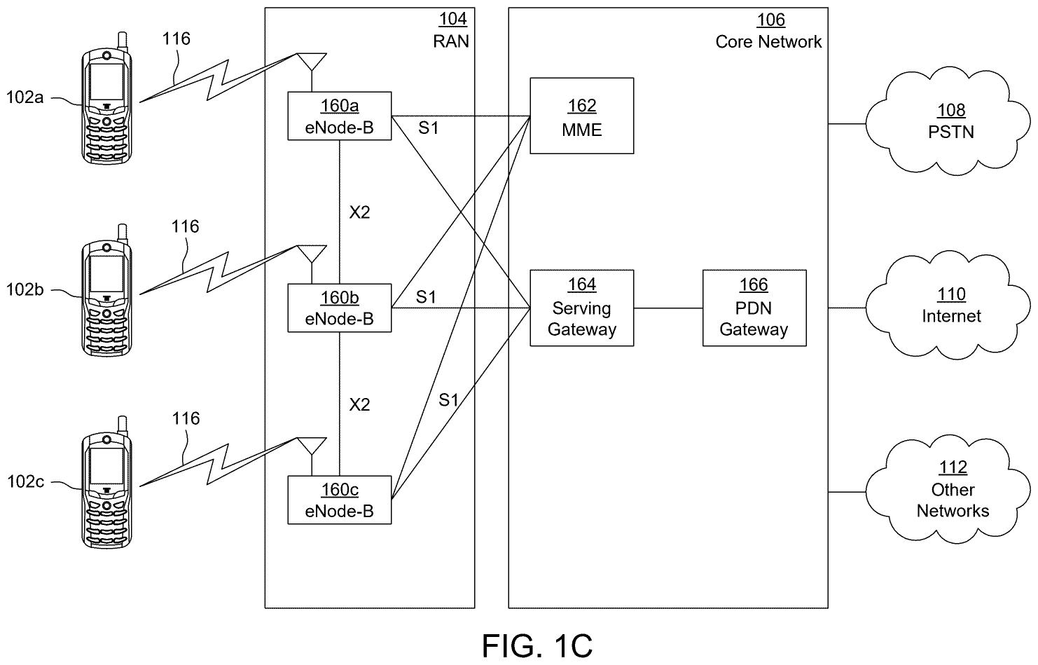

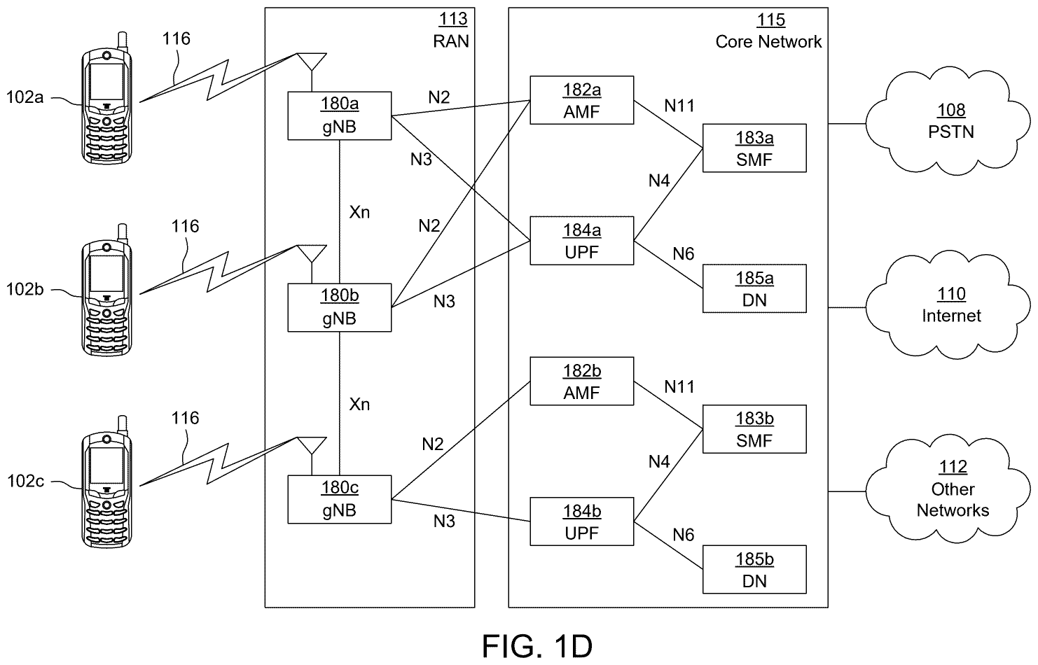

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, arc from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Massive MIMO is a successful technology. With increasing transmit/receive point (TRP) antenna array aperture and carrier frequency, the classical planar wave approximation no longer holds in an increasing part of the coverage area, called the near field (NF). Legacy far-field (FF) transmission and reception techniques suffer loss in the NF where the electromagnetic (EM) wavefronts must be accurately modeled as spherical waves instead of planar waves.

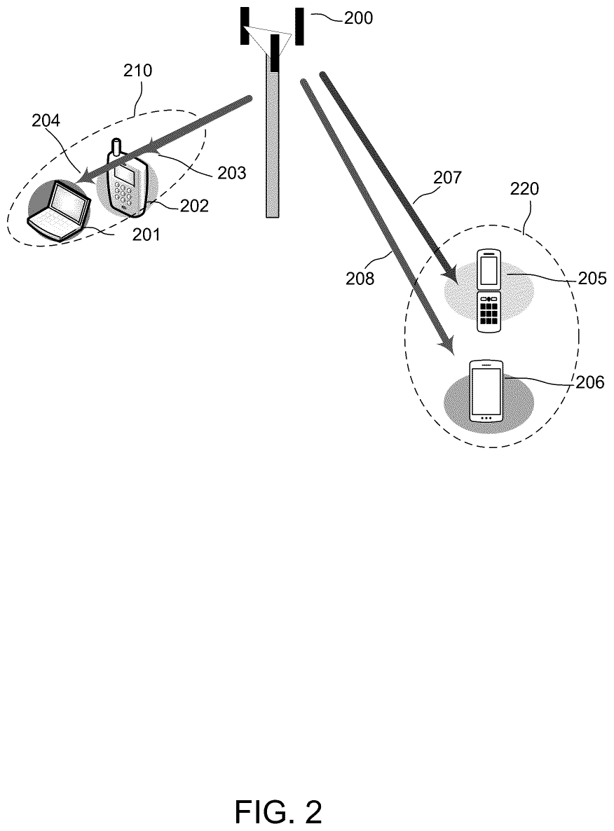

It may be beneficial if a WTRU and the NW are aware of whether the WTRU is within a NF region or not. This is because when the WTRU is in a NF region, techniques such as LDMA (Location Division Multiple Access) as shown in FIG. 2 and beam focusing could be enabled to enhance spectrum efficiency. In this FIG., 200 is a gNB or network node, 210 is an NF region, 220 is an FF region; 203 is a first NF (spot) beam in the NF (focus) region 210 targeting a first WTRU 202, 204 is a second (spot) beam in the NF (focus) region 210 targeting a second WTRU 201. As shown, the different NF beams are within a same spatial direction but with different (spot) distances. This results in the first WTRU 202 and the second WTRU 201 being (asymptotically) orthogonal, meaning that there is no mutual interference between the first WTRU and the second WTRU. Further in the figure, a third WTRU 205 and a fourth WTRU 206 are in FF region 220, where different FF beams target the different WTRUs; FF beam 207 targets the third WTRU 205, and FF beam 208 targets the fourth WTRU 206. The third WTRU 205 and the fourth WTRU 206 are separated (mutual interference is reduced) with the different spatial direction of beams 207 and 208.

To enable this in NF, the first step is to recognize if a WTRU is in an NF region or not. Although there are existing solutions to obtain the WTRU location information, e.g., sensing, positioning, etc., not all WTRUs may have this capability and this information may not be easily available to the gNB (the information could be known only deep within the network).

### Overview

In legacy systems (e.g., NR), the network may perform NF region detection based on a set of RSRPs reported by the WTRU. However, while NR is based on the WTRU reporting of the highest RSRPs (and associated CRIs) from a large set of CSI-RS resources, the NF region detection may be based on the comparison between one of the highest RSRPs and one of the lower RSRPs. Hence, to facilitate the network-side NF region detection, the WTRU may need to report a large set of RSRPs, and preferably periodically, to facilitate timely NF region detection. On the other hand, with WTRU-side NF region detection, RSRP reporting isn't required, and the WTRU may just indicate the change of NF/FF region when it happens, resulting in less UL reporting overhead.

Furthermore, a purpose of NF/FF region detection may be to subsequently enable/disable NF-specific WTRU methods. Examples may include adjusting the WTRU configuration of the WTRU enable (or switch) a procedure to the use of an NF codebook (e.g. NF-specific codebook) for CSI acquisition in case of NF region detection (and use (enable/switch to the use) of non-NF specific codebook (FF codebook) in case of FF region detection), the WTRU using a NF-specific measurement and reporting configuration, the WTRU using a NF-specific mobility configuration, etc. For WTRU-side NF/FF region detection, the WTRU may start to use the NF-specific WTRU method directly upon NF region detection. For WTRU-side NF region detection, the WTRU may indicate the change of NF/FF region in a subsequent UL transmission, e.g., in a CSI report (based on NF codebook), a measurement report (based on a NF-specific measurement and reporting configuration), etc. On the other hand, for NW-side NF region detection, the WTRU might not start to use the NF-specific WTRU method until it has received an indication from the network. Hence, WTRU-side NF/FF region detection can also give faster switching to/from NF-specific WTRU methods.

In legacy NR, the RSRPs that correspond to different DL RS and that are reported by a WTRU may correspond to different WTRU Rx beams, as the WTRU Rx beam used to receive a DL RS is up to the WTRU implementation, even if the DL RSs are QCL-Type D. However, in order to achieve reliable NF/FF region detection, the same WTRU Rx beam should be used for measuring the RSRPs used for NF/FF region detection. Hence, NF/FF detection based on the legacy NR RSRP reporting might not be reliable.

In view of the previous, it is therefore advantageous to achieve efficient NF/FF region detection at the WTRU side.

According to an embodiment, a WTRU report(ing) of NF/FF region status to the network (network node) is triggered upon detection (determining) by the WTRU of a NF/FF region change. The WTRU may determine the NF/FF region based on comparing at least two (sets of) RS measurements (e.g. each set being transmitted from the network using a different set of antenna elements/subarrays) to at least one configured threshold.

Steps of a method according to an embodiment that may be implemented by a WTRU according to an embodiment are summarized hereunder. Details will be handled further on in this document.

### WTRU Actions/Steps:

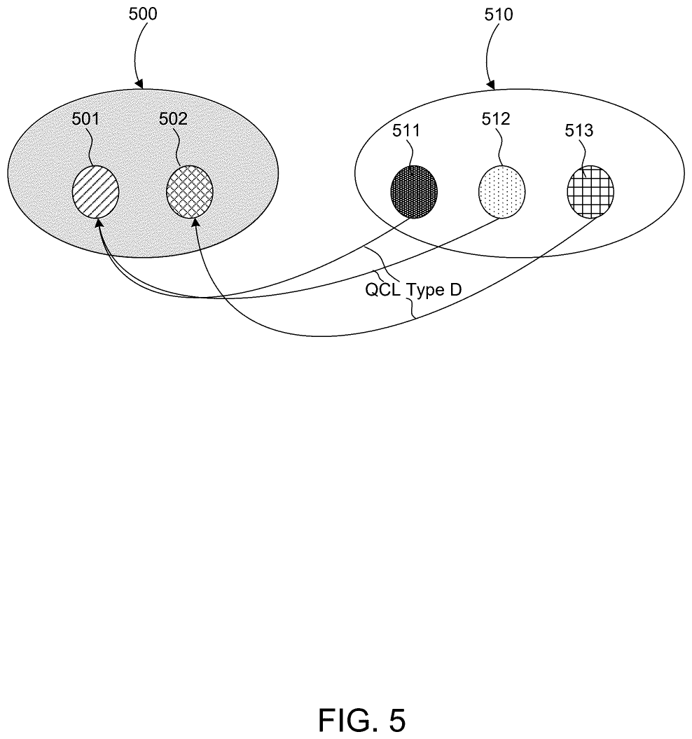

In a first step, a WTRU is configured with a primary and a secondary set of RS resources from higher layers (e.g., RRC):
1a) each RS from the secondary resource set is associated with an RS from the primary RS resource set, e.g., implicitly by a QCL relation between a primary and a secondary RS resource;
1b) multiple secondary RS resources may be associated with a same primary RS resource, as illustrated in FIG. 5;
1c) each RS group resource may be configured with a threshold.

In a second step, the WTRU is further configured with a report configuration from higher layer (e.g. RRC) that includes at least one of; report quantity, trigger states, thresholds, uplink resource for reporting, etc.

In a third step, the WTRU performs a measurement, e.g., an RSRP/SINR measurements, on each pair of associated RS resources selected from the primary and the secondary sets, wherein the WTRU obtains the measurements using the same WTRU Rx beam.

In a fourth step, based on the measurement results, the WTRU selects one or more RS groups, where an RS group comprises a secondary RS resource and the associated primary RS resource. For example, the WTRU selects an RS group with the highest (or filtered) measured RSRP/RSRQ/SINR.

In a fifth step, for each selected RS group, the WTRU determines whether a pre-defined measurement condition is fulfilled. For example, for an RS group, a NF/FF criterion comprises determining if the difference between the measured RSRP/SINR of the first and second RS resources in the group meets a configured threshold.

In a sixth step, based on the determined state for the selected RS group(s), the WTRU determines to transmit a status report, e.g., a status report comprising the NF or FF status, based on at least one of the following:
6a) if the determined state of at least one or the selected RS groups has changed;
6b) based on a received indication/configuration from gNB, e.g., an aperiodic, periodic, semi-persistent CSI report (note: NF/FF region status report may combine with other CSI reporting e.g., RSRP/SINR. Etc. Note: the RS configuration includes the resource which specifies the time and frequency resources of RS.

According to an embodiment, primary RS is an FF sub-array beam and secondary RS(s) is a set of full array FF beams, “within” sub-array FF beam, i.e., full array FF beams QCL-D with sub-array FF beam. In another example, primary RS could be a Full array FF beam and secondary RS(s) could be a set of full array NF beam, corresponding to different focus distances, but with the same QCL direction as primary resource beam, i.e., full array FF beams QCL-D with secondary NF beam.

WTRU-side NF/FF region detection has the benefit of less CSI reporting (e.g. RSRP/RSRQ/SINR) and higher reliability due to WTRU control of Rx beam used for measurement of RSs in a group. Furthermore, with WTRU-side NF/FF region detection, WTRU NF/FF behavior switching can be faster, e.g., the switching time can be done within a couple of ms.

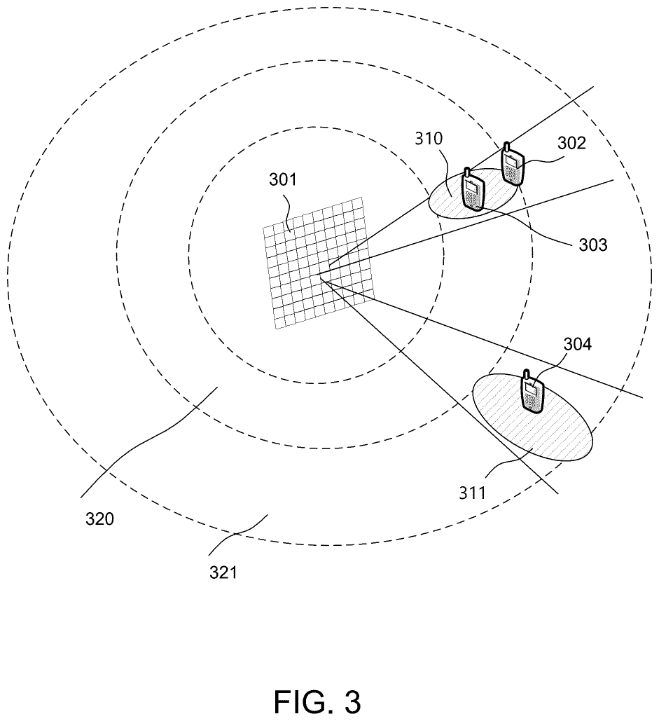

As shown in FIG. 3, different WTRUs, e.g., a first WTRU 303, a second WTRU 302, and a third WTRU 304) may enter a different NF region (e.g. NF region 321) or a same NF region (e.g., NF region 310) (e.g. a NF region is covered by a specific NF beam; WTRUs 302 and 303 are covered in NF region 320 by spot beam 310, while WRTU 304 is covered in NF region 321 by spot beam 311) depending on the WTRU's location with regard to the gNB's antenna array 301. A WTRU may monitor different RS which are associated with an NF region (e.g. an NF beam coverage) and once the WTRU detects (determines) that it enters/has entered/has moved into a particular NF region, the WTRU may trigger a reporting of entering an NF or FF region. The FIG. shows that unlike classical (legacy) spatial domain multiple access, and while WTRU 301 and WTRU 302 are in a same spatial direction, NF beams can serve both WTRUs 301 and 302 without interference.

What follows is a more detailed description of what has been described previously. The same step numbering (first step-sixth step) as previously used is therefore used here.

Summary of this embodiment: A WTRU report of NF/FF region status is triggered upon WTRU detection (detection/determination by the WTRU) of a NF/FF region change. The WTRU determines the NF/FF region based on comparing RS measurements (e.g. transmitted RS(s) from the network using a different set of antenna elements/subarrays).

In a first step, a WTRU is configured with polarity RS resources or RS resource sets from higher layers (e.g., RRC). The WTRU may receive the multiple RS resource sets which may include a primary RS set and a secondary RS set:
1a) an RS from a (e.g. secondary) resource set may be QCLed with an RS from the another (e.g. primary) RS resource set. In other words, RS among different RS resource sets may have the association e.g. via using QCL assumption. For example, the WTRU may be configured with two RS resource sets, e.g. primary RS set and the secondary RS resource set and an RS in the secondary resource set may be configured with QCL assumption for an RS in the primary resource set. According to an embodiment, multiple RS resources may be QCLed with an RS resource;
1b) some RS resources may be associated with location or distance information or a flag e.g. to indicate those RS resources are with NF beams/spot beams and those RS can be used for NF region detection;
1c) an RS resource or RS resource sets can be configured via RRC signalling and some (or subset of) RS resource or RS resource sets could be activated via DCI or MAC-CE via RS index/indices or a codepoint for a RS resource table, where each codepoint (an entry/a row to a table) is with a single or multiple RS indices for a RS resource table.

In a second step, the WTRU is configured with a report configuration from higher layer (e.g. RRC) for NF/FF region detection that includes at least one of; report quantity, trigger states, threshold(s), uplink resource for reporting, etc.
2a) report quantity could include RSRP/SINR, RS or RS ID, etc.;
2b) trigger states refer to NF/FF region status, for example, the NF/FF region status may be one of a multiple of different region statuses, e.g., in NF, between NF-FF (region) or in FF (region);
2c) threshold may be independent on RS or RS dependent. In other words, RS dependent threshold means a threshold may be configured for a configured RS. RS independent threshold means a threshold can be used or applied for all configured RS. If a RS is associated with a specific threshold, then WTRU knows this threshold is a RS dependent threshold.

In a third step, the WTRU may perform a measurement for performing the NF/FF region detection based on the configuration, e.g., the WTRU may be configured to use L1- or filtered (L3) RSRP/SINR measurement, on RS resources RS resource sets, wherein the WTRU obtains the measurements using the same WTRU Rx beam:
3a) the WTRU may perform RS grouping from RS resource sets. The WTRU may look up the QCL information between RS resource sets, e.g. from the primary and the secondary RS sets. The WTRU may determine one or more groups of RSs, wherein a group comprises an RS from a RS resource set and a RS from the other RS resource set with the configured QCL relation;
3b) The WTRU may perform the measurement for each RS in a RS group and apply a threshold for a RS group for the determination whether the WTRU has entered an NF region or not.

Based on the measurement results, the WTRU may select one or more RS groups, where an RS group may comprise an RS resource (from a secondary RS set) and another RS resource set (from a primary RS set). The WRTU may select an RS group or multiple RS groups with the best (or filtered) or with the best K (K>1) measured RSRP/RSRQ/SINR.

In a fifth step, for each selected RS group, the WTRU determines whether a pre-defined measurement condition is fulfilled; for example, for an RS group, an NF/FF (region) status criterion may comprise determining if a difference between the measured RSRP/SINR of the first and second RS resources in the RS group meets a configured threshold. For example, the detection criterion may be that the measured RSRP_{i∈S-RS}>RSRP_{j∈P-RS}+x [dB] is satisfied.

In a sixth step, based on the determined state for the selected RS group(s), the WTRU may determine to transmit a status report, e.g., NF/FF status, based on at least one of the following:
6a) the WTRU may report the status change if the determined state of at least one or the selected RS groups has changed, in this case, this kind of reporting may be referred to as conditional reporting;
6b) the reporting may be based on a received indication/configuration from a gNB, e.g., an aperiodic, periodic, semi-persistent CSI report, or conditional report (note: the NF/FF region status report may be combined with other CSI reporting e.g., RSRP/SINR reporting, etc., Note: the RS configuration may include the resource which specifies the time and frequency resources of RS.

### Configuration

According to an embodiment, NF region detection is configured with a report configuration that includes at least one of; report quantity, triggers, thresholds, uplink resource for reporting.

NF region detection reporting configuration may be based on the following options, e.g.: periodic or semi-persistent;
aperiodic trigger-based which may include L2 MAC-CE, L3 RRC-based, L1-DCI-based trigger.

Details of configuration are discussed as follows.

### Configuration of RS Resource Sets

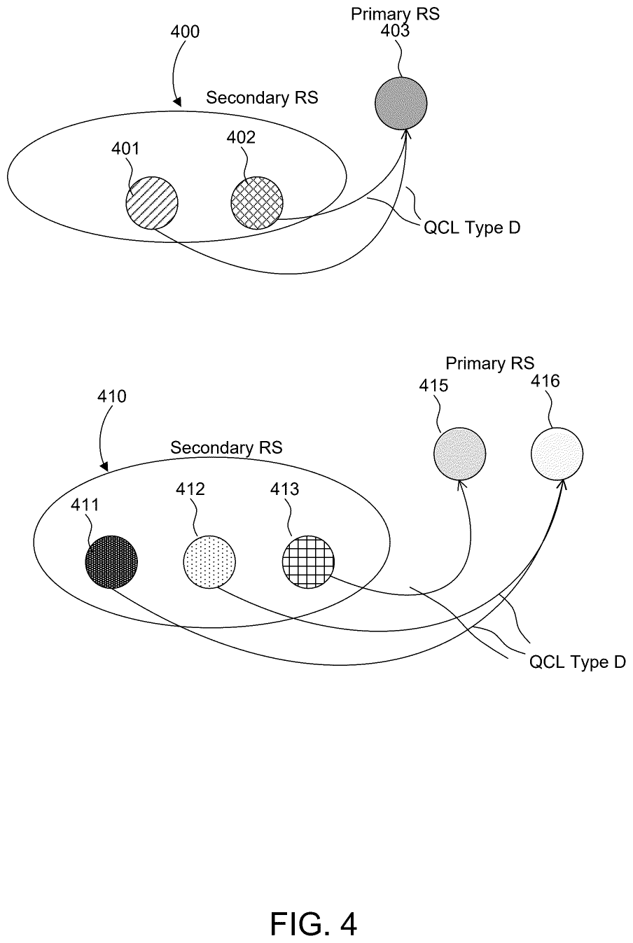

Configuration for NF region detection: a WTRU may be configured with one or more CSI resource set(s), e.g., a secondary RS resource set and/or a primary RS resource set, and there may be one or more CSI resource(s)/RS(s) in each CSI resource set. Each CSI resource/RS within the same resource set may be transmitted from the same TRP. Each RS in a set may be associated with a QCL relationship with one RS as shown in the exemplary configuration in FIG. 4. In this proposed configuration method, the CSI resource in the CSI resource set can be used for the secondary RS and the QCLed RS is the (e.g., implicitly indicated) primary RS. For an example configuration shown in FIG. 4, two CSI resource sets (a first CSI resource set 400 and a second CSI resource set 410) are configured for a WTRU, the first CSI resource set 400 is configured with two CSI resources/RSs, e.g. RS2 (reference 401) and RS 3 (reference 402) and the second CSI resource set 410 is configured with three RSs (e.g. RS 6 (reference 411), 7 (reference 412) and 8 (refence 413)). In CSI resource set 1, RS 2 and RS 3 are QCLed with an RS (e.g. RS 1 (reference 403)), e.g., RS 1 is a QCL source RS for RS 2 and RS 3. In this case, RS 1 is the primary RS for (secondary) RS 2 and 3 in CSI resource set 1. In this exemplary configuration, RS 6 and RS 7 are QCLed RS 4 (reference 416), and RS 8 is QCLed with RS 5 (reference 415). In the CSI resource set 2, RS 4 is the primary RS for (secondary) RS 6 and RS 7, and RS 5 is the primary RS for (secondary) RS 8. According to an embodiment, the WTRU may be configured with a secondary RS resource set and by an association between the secondary RSs and primary RS(s) may determine a corresponding primary RS resource set, wherein the association is further discussed below.

Another configuration for NF region detection according to an embodiment is where a WTRU may be configured with at least two RS (e.g. CSI-RS) resource sets. In this embodiment, one RS resource set may be defined or configured as the primary RS resource set and the rest of the RS resource sets can be defined as the secondary RS resource set(s) as shown in FIG. 5. The RS resource/RS in a secondary RS resource set may have a QCL relationship, e.g., are QCLed (e.g. Type D) with a RS resource/RS in the primary RS resource set. For example, as shown in FIG. 5, two RS resource sets are configured, i.e., one RS resource (set A with reference 500) is for primary set and the other is for the secondary set (set B with reference 510). The primary RS set comprises RS 1 (reference 501) and RS 2 (reference 502) and the secondary RS set comprises RS 3 (reference 511), RS 4 (reference 512), and RS 5 (reference 513). In this embodiment, various RS in the same RS resource set may be from the same TRP or different TRP.

According to an embodiment, a configuration of an RS resource set may comprise an indication that the resource set is a primary resource set. A configuration of an RS resource set may comprise an indication that the resource set is a secondary resource set. The WTRU may receive a configuration that configures one or more primary resource set(s), e.g., a resource set ID or a list thereof. The WTRU may receive a configuration that configures one or more secondary resource set(s), e.g., a resource set ID or a list thereof. The WTRU may receive a configuration that configures one or more pairs of resource set(s), e.g., comprising a primary resource set and a secondary resource set. A configuration of multiple pairs may comprise a list of pairs. For one embodiment, the resource sets are setup via RRC signalling but the activation of some (or subset of) RS resource sets may be done via DCI or MAC-CE via an index or using a codepoint (for a table).

### Configuration of Associations

A WTRU may be configured with one or more associations between groups of RSs, e.g., two RSs. The association configuration can for example include the following information:
QCL relation only; or
QCL relation and distance information; or
explicit association configuration, e.g., B-RS signal Tx power.

The QCL information may be an association between the primary RS and secondary RS. For example, as shown in FIG. 4, a configured CSI resource/RS 2 and RS 3 are QCLed with RS 1. The WTRU may determine that two RSs are associated if one of the RSs, e.g., a primary RS, is a QCL source RS of the other RS, the target RS, e.g., a secondary RS. The QCL relation may be configured using TCI states, wherein a QCL source RS may be configured in a TCI state with a TCI state Id, and the TCI state Id is configured for the target RS. In various cases, a TCI state for a target RS, and thereby an association between two RSs, may be indicated to the WTRU with one or more of RRC configuration, MAC CE, and/or DCI.

In addition, according to an embodiment, a distance-related parameter, e.g., distance information or location information, may be associated with primary RS and/or secondary RS. For an exemplary configuration according to an embodiment, an RS may be configured with a distance information which corresponds to the spot beam (focus) distance. In this case, the focus distance may be treated as an explicit way to indicate the spot beam information such that WTRU may use this information for NF/FF region detection, e.g., by determining a region based on the distance corresponding to a measured RS, e.g., the RS with highest measurement metric within a set of measured RS(s).

According to an alternative embodiment, the WTRU may be configured with one or more explicit associations, wherein an explicit association is an association between an RS in a primary resource set and an RS in a secondary resource set. Multiple secondary RS may be associated with the same primary RS. In some cases, multiple primary RS may be associated with the same secondary RS. In some cases, the RS(s) in a secondary resource set may be associated with RS(s) in the same primary resource set, e.g., the primary resource set in the same pair as the secondary resource set. In some cases, the RS(s) in a primary resource set may be associated with RS(s) in the same secondary resource set, e.g., the secondary resource set in the same pair as the primary resource set.

### Multi-TRP Configuration Aspects

In some cases, the WTRU may be configured with multiple pairs of primary RS and secondary RS sets. The WTRU may be configured to perform, and hence may perform, multiple parallel NF/FF region detections based on the multiple pairs of resource sets. The RSs in a pair of sets may be transmitted from the same TRP, while RSs in different pairs of sets may be transmitted from different TRPs. A WTRU may be in the near field of a first TRP while in the far field of a second TRP, etc. In some cases, a WTRU may be in the near field of multiple TRPs simultaneously. A network that has knowledge of such topological properties may configure the WTRU with sets of possible states. In a simple example with two TRPs, e.g., with two corresponding pair of resource sets, the network may configure the WTRU with a first possible state as (NF for TRP 1 and FF for TRP 2), a second possible state as (FF for TRP 1 and FF for TRP 2), and a third possible state as (FF for TRP 1 and NF for TRP 2). By excluding some states from the possible states, the WTRU may avoid reporting an invalid (not possible) state. The reporting can be based on UCI Furthermore, the number of reporting bits may be reduced, depending on the number of NF/FF regions and the number of TRPs.

### Configuration of NF/FF Region Detection

According to an embodiment, a WTRU may be further configured with the following for NF/FF region detection and/or reporting: a threshold, e.g., RS independent threshold, and/or (multiple) threshold(s), e.g., RS dependent threshold(s), for NF/FF region detection.

A WTRU may be configured with one or more than one threshold for NF/FF region detection. If a CRI or a CSI resource set is configured with a (individual) threshold, then we call this case as RS dependent threshold configuration. Otherwise, a threshold is applied for multiple, e.g., all, (e.g., secondary) RS/CSI resource set then we call this configured threshold is a RS independent threshold.

In another embodiment, RS dependent thresholds (i.e., Threshold_i) may be configured, where RS dependent Threshold_i may capture that different B-RSs (e.g. full array FF beams) are more or less aligned with the B-RS (e.g. sub-array FF beam) main direction, wherein i may correspond to an RS index in an secondary RS resource set (e.g. CRI). It is noted that the threshold introduced here may, but not limited to, be configured in a unit of RSRP, e.g., dBm, or SINR, e.g., dB, or a corresponding value in linear scale.

According to an embodiment, an RS (e.g., beam) dependent threshold can be applied for the determination of NF/FF region detection and this threshold may be configured via higher signaling (e.g. RRC) for the configuration of B-RS and/or A-RS.

According to an embodiment, the WTRU may determine RS thresholds based on antenna virtualization information configured for instance for one or more CSI resources in the primary and/or secondary CSI resource/RS.

According to another embodiment, the RS dependent threshold may be a virtualization information as a factor M_k, for instance representing a ratio between the number of antenna elements per secondary RS antenna port and the number of antenna elements per primary RS antenna ports, for a k-th RS resource set; or alternatively for a i-th RS resource in a RS resource set. The factor may be configured in linear scale or dB scale. For example, M_k can be derived from the ratio of the number of antenna element of the secondary RS to the number of antenna elements of the primary RS.

According to an alternative embodiment, the WTRU may be configured with one or more vectors comprising different ranges e.g., each vector includes multiple different thresholds like a set of thresholds {Threshold 1, Threshold 2, . . . . Threshold M}. A configured vector may be RS independent or RS independent (e.g., one vector may be shared between one or more RS).

Besides, according to an embodiment, a threshold may be configured with multiple values and this may be indicated by a table (e.g. pre-defined table) or may be configurable and the configured threshold may be quantizable and may be indexable.

According to an embodiment, the WTRU may detect and report to the NW in which range the calculated metric falls, e.g., the range below the lowest threshold among the multiple thresholds, or the range between two threshold values.

### Configuration of Reporting of NF/FF Region

Configuration of reporting of NF/FF region concerns types of feedback, e.g., periodic, semi-persistent or aperiodic, and UL resource for feedback.

When NF/FF region detection reporting configuration is periodic or semi-persistent:
a) NF/FF region reporting configuration may be based on periodic RS resources, and/or NF/FF region reporting may be configured in relation to other legacy CSI reporting configuration like L1-RSRP or L1-SINR with different reporting period, e.g. with periodic RS resource(s) e.g., 40 ms for (L1-) RSRP/SINR report but NF/FF region report period, e.g., 160 ms is configured. For example, NF/FF region detection report may be configured to multiple (integers) of periodic RS;
b) the feedback/reporting of UL resource may be on PUCCH (a part of UCI) or PUSCH if scheduled.

When NF/FF region detection reporting configuration is aperiodic:
a) NF region reporting can be based on aperiodic DCI triggering. For instance, a DCI can trigger WTRU to perform NF region reporting and report based on aperiodic RS resources. For example, a group of L aperiodic (CSI-) RS resources (may include primary and secondary RSs) are configured for a WTRU to perform NF region detection and reporting within a configured duration, e.g. in terms of ms or number of slots. In aperiodic reporting, WTRU may assume the validity of RS for NF/FF region detection before WTRU reporting. The first RS/beam (which may include primary and secondary RSs) is the configured RS resource which is starting at the OFDM symbol l and the next repeated RS/beam may configured at OFDM symbol l+M where M is denoted as the RS resource (e.g. M=14) occurrence location, e.g., configured RS can be expressed as l, l+M, . . . (L−1)*M. Therefore, when the last RS configured is received for a WTRU, the WTRU may report aperiodic NF/FF region detection report after a scheduled time;
b) the feedback/reporting of UL resource may be on PUCCH (a part of UCI) or PUSCH if scheduled.

According to another embodiment, a WTRU may be configured with NF/FF region detection with conditional reporting. Here, the conditional reporting may refer to WTRU-initiated reporting of NF/FF status, e.g., due to status change.

When NF/FF region detection reporting configuration is based on conditional reporting, NF region reporting may be configured to conditional reporting, i.e., WTRU only reports when the status of NF/FF region detection has changed.

A WTRU may report the NF/FF region status via PUCCH (e.g. a configured resource) or PRACH (e.g., contention-free PRACH), or WTRU may request a PUSCH. For instance, the WTRU may be configured with different PRACH resources (incl. preamble sequences) that correspond to different NF/FF regions or statuses. The WTRU may indicate NF/FF status change by transmitting a PRACH resource corresponding to the new status.

In short, according to an embodiment, the resources for feedback may be dependent on the types of feedback. For example, the feedback of UL resource is based on PUCCH (a part of UCI) when periodic, on PUSCH when semi-persistent or aperiodic, or on PRACH (e.g. contention-free PRACH) when conditional reporting.

According to an embodiment, the NF/FF region reporting may be configured to be standalone, for instance as described for PRACH above or in a UCI carrying only the NF/FF region reporting, e.g., on a PUCCH. The WTRU may be configured with WTRU-initiated NF/FF region reporting on PUCCH, for instance similarly as a scheduling request (SR) for short format of PUCCH, e.g., such that a region indication corresponds to a logical channel, with a logical channel identity, triggering an SR.

According to an embodiment, the NF/FF region report may be configured to be piggybacked on, or included in, another UL report, such as a CSI report. For instance, a WTRU may be configured to report one or more measurements, e.g., RSRP, for a resource set, e.g., a secondary or primary set. A WTRU may include a NF/FF region status corresponding to the resource set on which the CSI report is based. In an example, the WTRU reports an RSRP or SINR and/or CRI based on a secondary resource set. A WTRU may include a NF/FF region status corresponding to the secondary RS indicated by the CRI.

According to an embodiment, a WTRU may be configured with a detection time window and/or a detection number M. A NF/FF status report may be triggered if the number of NF/FF region detection events within the time window is equal to M or greater than M.

According to an embodiment, the WTRU may be configured with secondary resource set that in addition may comprise a current beam RS. The current beam RS may correspond to an RS in an indicated TCI state, e.g., the RS with QCL type D if multiple RS are configured in the TCI state, wherein the TCI state indication may be carried in a DCI or MAC CE. The indicated TCI state may be applicable to PDCCH and/or PDSCH reception. Alternatively, the current beam RS may correspond to the SSB that is QCL with the RS in the indicated TCI state.

According to an embodiment, a WTRU may be configured to report NF/FF region detection using one or more MAC CEs. In this case, NF region detection can be triggered by higher layer and higher layer may use filtered L1 measured results (e.g., RSRP/SINR) for monitoring NF region detection and NR region detection report and triggering may be based on MAC layer/L2.

According to an embodiment, the WTRU may be configured to report NF/FF region status using RRC signaling. The reporting may be configured to be periodic or event-based. For event-based reporting, one or more events with associated parameters, such as thresholds, hysteresis, etc., may be configured. A threshold configured for NF/FF region detection may be applicable in a condition for an event. An event may be equivalent to a NF/FF detection criterion described herein.

### Configuration of NF/FF Region Detection Indication

According to an embodiment, aWTRU may be configured to report one or any combination of the following to indicate NF/FF region detection:

a variable (e.g., binary, or Boolean variable) indicating change of the propagation field. For instance, WTRU reports 0 in case WTRU determines no change in the propagation field. Alternatively, WTRU reports 1 in case it detects change in the propagation field; one or more indices reflecting one or more determined ranges by the WTRU. For instance, the different reported indices may correspond to performed calculations on different RSs, secondary RSs, primary RSs, groups of RS (i.e., pairs of RS), etc. The reported indices may correspond to ranges from same or different configured threshold vectors (e.g., based on the configurations of the vectors comprising different ranges).

Configuration of NF Configuration and/or FF Region Configuration for Data Transmission

For a WTRU to perform DL data reception (e.g. PDSCH), CSI reporting and/or UL data transmission (e.g. PUSCH), the WTRU may be configured with a first configuration that the WTRU should use when in the FF, e.g., a legacy configuration. The WTRU may be configured with a second configuration that the WTRU may use when in the NF, e.g., a configuration corresponding to NF-enhanced WTRU methods. For example, the first configuration may comprise legacy L1 or L3 measurement/reporting configuration(s), and legacy CSI codebook and/or CSI reporting configuration(s), etc. The 2nd configuration may include NF specific codebook(s) for CSI-PMI-RI reporting, PUSCH transmission and some RS resources or RS resource sets may be enabled or activated for NF region detection and reporting.

According to an embodiment, the WTRU may be configured to switch between the first and second configurations upon NF/FF region status change, e.g., upon reporting of NF/FF region status change. The WTRU may be configured to switch between the first and second configurations only upon network confirmation or indication of NF/FF region status change.

### NF/FF Region Detection

### RS Grouping and Measurement

According to an embodiment, a WTRU may perform RS grouping between primary RS and secondary RS based on the given configuration, e.g., via QCL relation for NF/FF region detection when the WTRU starts to perform NF/FF region detection. In a first embodiment, the WTRU may group the primary RS and secondary RS based on configured QCL information. In a second embodiment, the WTRU determines one or more groups of two RSs, wherein a group comprises an RS from the secondary RS/CSI-RS resources set and an RS from the primary RS/CSI-RS resource set with the configured QCL relation. The RS grouping is performed by the WTRU and each RS group may contain at least an RS from the secondary RS and at least an RS from the primary RS. In other words, the primary RS in a group may be a QCL source RS for the secondary RS in the group. In each group, there are two RSs, i.e., one is from the primary RS and the other is from the secondary RS, and the WTRU may group RSs based on the configured QCLed relation. In other embodiments, the WTRU may determine RS groups by other means, e.g., by explicit group configuration(s).

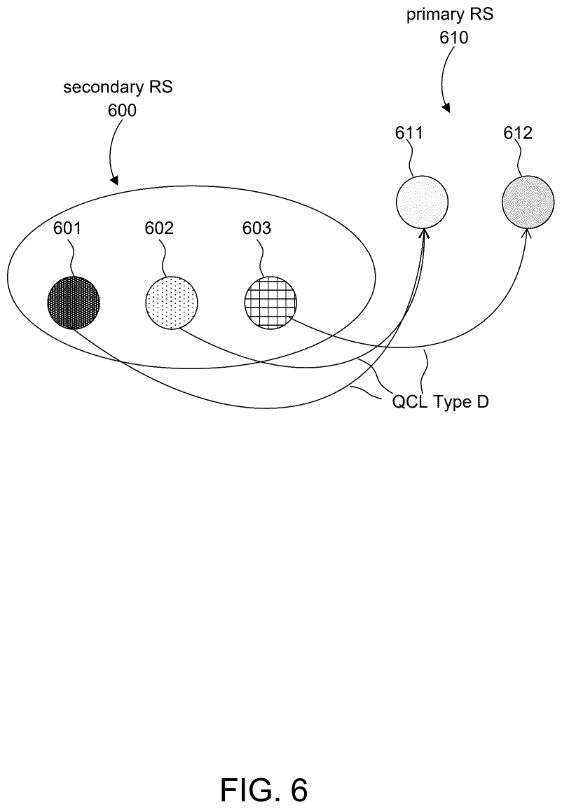

For an exemplary embodiment as shown in FIG. 6, a WTRU may group from primary RS (reference 610) {RS 4 (reference 611)}, {RS 5 (reference 612)} and secondary RS (reference 600) {RS 6 (reference 601), RS 7 (reference (602)}, {RS 8 (reference 603)} into three groups via the QCL relation, i.e., a first group {RS 4, RS 6}, a second group {RS 4, RS 7} and a third group {RS 5, RS 8} for a CSI resource set as depicted. According to an embodiment, the WTRU may repeat this operation for all configured CSI-RS resource sets (note: different RS resource set may be from different TRPs).

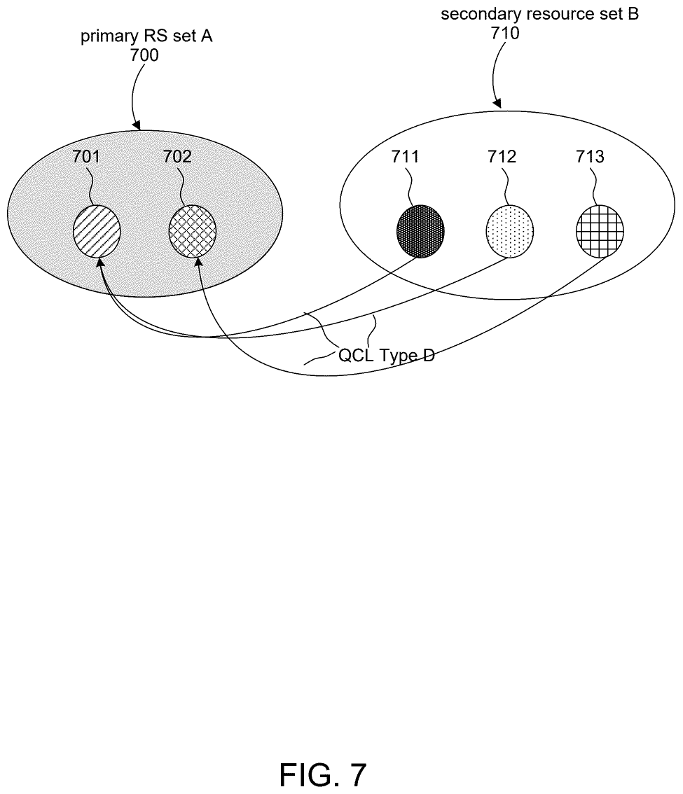

In another exemplary embodiment as shown in FIG. 7, the primary RS set (reference 700) comprises RS 1 (reference 701) and RS 2 (reference 702) (RS1 and RS 2 are sub-array FF beams). The secondary RS set (reference 710) comprises RS 3 (refence 711), RS 4 (reference 712) and RS 5 (reference 713). In addition, RS 3 and RS 4 are QCLed (type D) with RS 1 and RS 5 are QCLed (type D) with RS 2. Therefore, we have 3 possible groups, i.e., {RS 1, RS 3}, {RS 1, RS 4} and {RS 2, RS 5} as shown in the FIG. The WTRU may determine only the group comprising the secondary RS with the highest L1-RSRP or L1-SINR.

After determining of the grouping, the WTRU may perform measurements for one or more grouped RS, e.g., for each grouped RS, wherein the WTRU may obtain the measurement results of a secondary RS resource and the associated primary RS resource using the same WTRU Rx beam (e.g., due to QCLed information). Note that a WTRU may be required to perform measurements on the RSs in a group using the same WTRU Rx beam, which may be a stricter requirement than for measurements on QCLed RSs. It may, for example, be up to WTRU implementation if it uses the same or an adjusted beam for a target RS as for the corresponding QCL source RS. Based on the measurement results, the WTRU may select one or more RS groups, wherein an RS group comprises a secondary RS resource and the associated primary RS resource. The one or more RS groups selected by the WTRU may be reported to the gNB.

Exemplary measurements include RSRP, RSRQ such as L1-RSRP or L3 filtered RSRP, and SINR, such as L1-SINR or L3 filtered SINR.

According to an embodiment, the WTRU may be indicated by the gNB, e.g., through RRC signaling, of one or several RS groups that may be selected for corresponding measurements and/or reporting. Note: NW may signal the number of RS groups the WTRU needs to report. The WTRU may use the one or more measured RS groups, or a subset thereof, for NF/FF status detection. In one example, the WTRU may select an RS group for NF/FF status detection from the one or more groups, based on the measurement results. For instance, the WTRU selects an RS group comprising the secondary RS with the highest measurement result among the measured secondary RS(s).

According to another embodiment, the WTRU may be indicated by the gNB, e.g., through a RRC signaling, of a minimal number of RS groups that should be selected for corresponding measurements and/or reporting.

According to yet another embodiment, the WTRU may be indicated by the gNB, through a RRC signaling, of a maximum number of RS groups that should be selected for corresponding measurements and/or reporting.

It is noted that among the multiple RS groups, there may be a mandatory group indicated by the gNB that the WTRU should select for corresponding measurements and/or reporting. It is noted that, a number of RS groups selected by the WTRU for corresponding measurements and/or reporting may be determined by the WTRU based on at least the RRC signaling. In response to the measurement, the WTRU may report the number of measurement results to the gNB.

The secondary RS resource set may correspond to a configured set of RS(s) for new (candidate) beams, e.g., for WTRU-initiated beam reporting. In some cases, the secondary RS resource set also comprises an RS corresponding to an RS for a current beam. The corresponding primary RS(s) may be the SSB(s) that are QCL source(s) to the secondary RS(s).

### Determination of NF/FF Detection Criteria

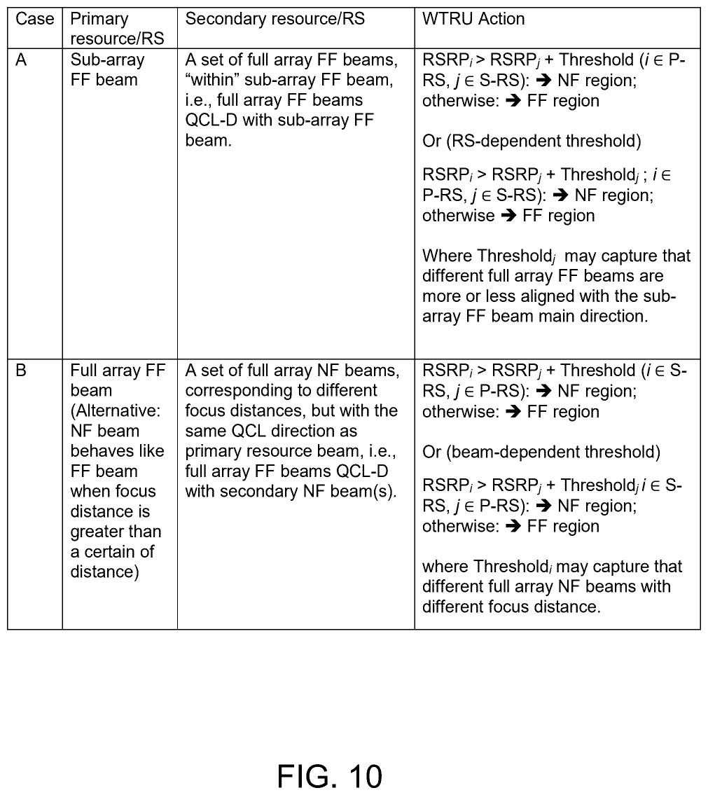

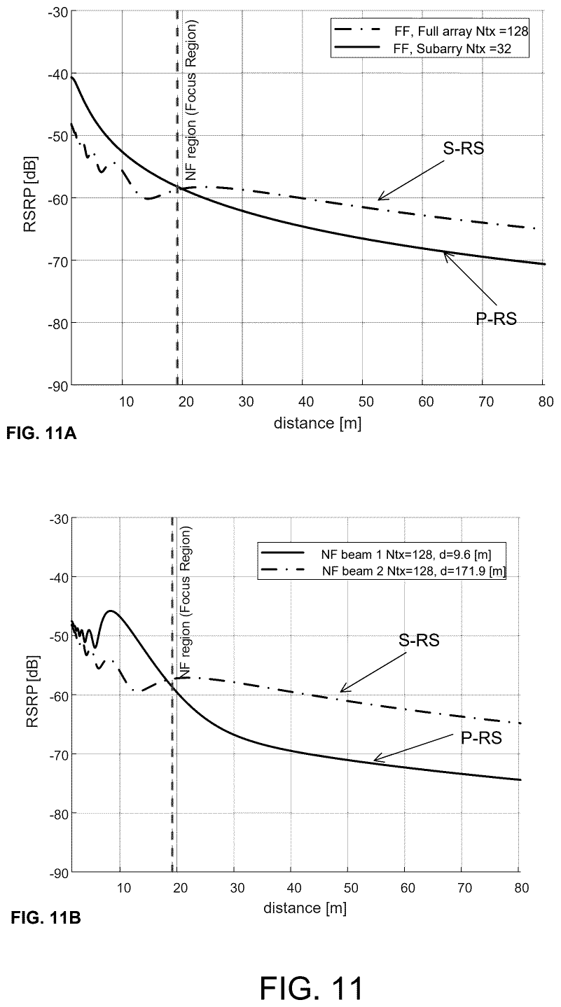

A WTRU may determine NF/FF regions for example as follows (a-c):
a) according to an embodiment, the WTRU evaluates one or more criteria RSRP_i>RSRP_j+Threshold (or Threshold_j) hold(s) or not for the select group RS, wherein i∈S-RS, j∈P-RS in the same RS group, e.g., i=4, j=6 if the RS group is {RS 4, RS 6}. If the detection criterion/criteria hold(s), e.g., all criteria or at least one criterion, then the WTRU determines that it is in NF region and vice-versa. Note: the sample principle can be applied if the measurand metric is based on SINR. For example, as shown in FIG. 11A corresponding case A in the table of FIG. 10 and FIG. 11B corresponding to case B in the table of FIG. 10, for a pair of selected RS group, the measured primary-RS RSRP outperform secondary-RS in a NF region, i.e., RSRP_(i∈S-RS)>RSRP_(j∈P-RS)+threshold (e.g. 3) [dB]. More WTRU action items for determination of NF/FF region can be found in the table of FIG. 10. The WTRU may evaluate the one or more criteria for a WTRU-selected set of RS groups, or an indicated/configured set of RS groups. The WTRU may evaluate the one or more criteria for RS groups corresponding to one or more secondary RS sets. The WTRU may perform multiple NF/FF region detections based on evaluations of criteria corresponding to different secondary RS sets, wherein the different secondary RS sets may correspond to different TRPs, for instance.
b) In case of multi-level threshold, according to an embodiment, the WTRU may detect a NF/FF region and report this to the NW if the calculated metric falls within a multi-level range. E.g., the configured ranges may have several thresholds and corresponding ranges, and the WTRU may determine if the measured RSRP (or SINR) falls into a range between two thresholds, e.g., Threshold_1≥RSRP_(i∈S-RS)-RSRP_(j∈P-RS)≥Threshold_(l+1), where Threshold_1 denotes the 1-th level threshold.
c) According to an embodiment, the WTRU may detect NF/FF region using one or any combination of the methods introduced above for NF/FF region detection. For example, the measured RSRP (or SINR)S-RS at least needs to be greater than a (minimal, configurable) threshold to be considered for NF/FF region detection criteria. Then, the WTRU can further examine whether the measure RSRP (or SINR) P-RS is greater than S-RS to a certain degree, e.g., RSRP_(i∈S-RS)>RSRP_(j∈P-RS)+x [dB], where x [dB] may be a configured RS independent threshold.

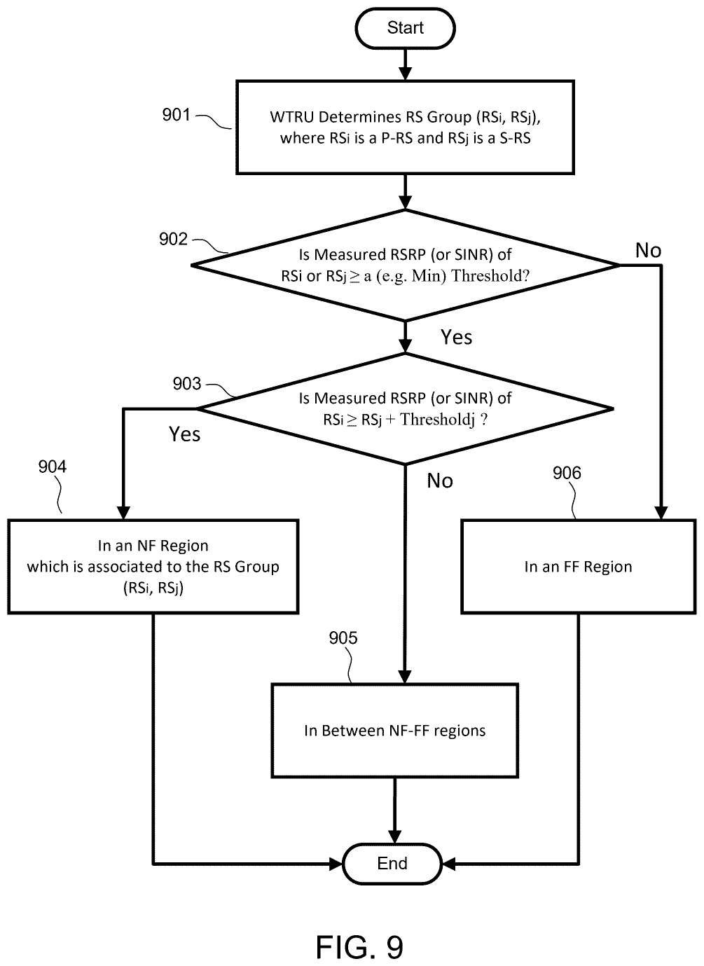

To illustrate the determination of NF/FF detection criteria, an exemplary method for a WTRU is shown in FIG. 9:

In 901, the WTRU determines RS groups from P-RS and/or S-RS (1a-1b):
1a) for example, there are three RS groups as shown in FIG. 6, i.e., three RS groups: {RS 4, RS 6}, {RS 4, RS 7} and {RS 5, RS 8};
1b) the WTRU may perform RS measurements based on the determined group(s) prior to criterion evaluation. For instance, the WTRU determine Rx beam(s) for the RS measurements based on the determined group(s), as described herein.

In 902-903, the WTRU evaluates the NF/FF region detection criteria for each determined RS group. For an exemplary criterion shown in FIG. 9, the WTRU may perform the following (2a-2c):
2a) the WTRU performs RSRP/RSRQ (e.g. L1-RSRP or L3-RSRP) or SINR (e.g. L1-RSRP or L3-RSRP) measurement for each determined RS group;
2b) In 902, the WTRU uses a threshold to check if P-RS or S-RS is qualified, i.e., is greater than the minimal threshold;
2c) In 903, the WTRU checks if the identified P-RS and S-RS group(s) meet(s) the NF/FF region determination criteria e.g., a NF/FF region determination criterion for P-RS and S-RS: RSRP_{i∈S-RS}>RSRP_{j∈P-RS}+x [dB] or not;

In 904-906, following the evaluation of the NF/FF region detection criteria for each determined RS group, the WTRU determines that the WTRU is:

In 904, in a NF region which is associated with this identified RS group; or

In 905, not in a NF region which is associated with this identified RS group; or

In 906, in an FF field (region).

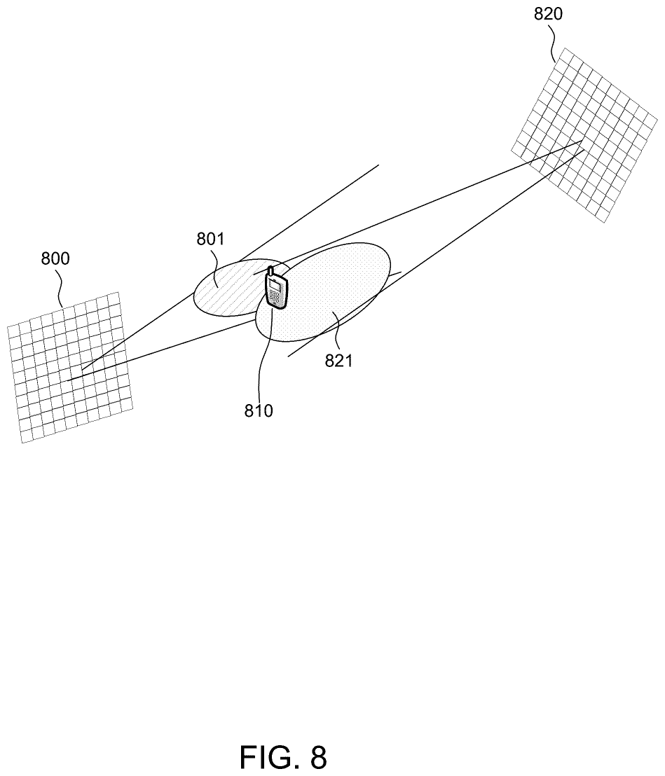

An RS group can be used for the indication of entering a NF region or not, therefore, when WTRU detects multiple RS groups satisfy the detection criteria, WTRU can assume WTRU may enter in multiple NF regions. For instance, as shown in FIG. 8, two TRPs (references 800 and 820) each have their own transmit beam with different NF region spot beams, i.e., NF region spot beam 801 for TRP 800, and NF region spot beam 821 for TRP 820. WTRU 810 is located in an area covered by both NF region spot beams 801 and 821. In this case, there are two RS groups e.g., a first RS group consisting of {RS 4, RS 6} and a second RS group consisting of {RS 5, RS 8} are selected/identified because WTRU 810 determines satisfaction with NF region detection criteria in both NF regions. Thus, selected or identified multiple (e.g. two) RS groups may present multiple or different NF regions. Note that those NF regions may be from different TRPs as shown in FIG. 8 or from a same TRP (not shown in FIG. 8). The WTRU may either further report the best K RS groups, or one of the RS IDs in an RS group of multiple RS groups when the WTRU detects multiple RS groups satisfying the detection criteria.

In addition, as shown in FIG. 9, the detection/determination whether the WTRU has entered/is in NF/FF region may be binary (e.g. in NF (904) or in FF (906)), or non-binary (e.g., in between NF-FF (905)).

The table in FIG. 10 shows different example embodiments of determination of NF/FF region based on primary RS (P-RS) and secondary RS (S-RS). The exemplary criteria are based on RSRP. In other embodiments, other metrics may be used, such as SINR. According to the example embodiments of the table of FIG. 10, primary RS can be based on sub-array FF beams and secondary RS can be based on (full-array) NF beams which its beamforming weight is associated with (different) spot distance. Based on the configuration and beam setup, A WTRU can perform (L1 or L3)-RSRP/(L1 or L3)-SINR comparison between primary RS and secondary RS in a RS group to determine whether WTRU is close to the transmitter array or not.

FIG. 11 illustrates two examples where primary RS and secondary RS based on different scenarios such as case A and B as shown in the table of FIG. 10. In FIG. 11A (case A), Primary RS corresponds to a sub-array FF beam with ULA number of transmit elements in antenna array (Ntx)=32 and secondary RS corresponds to a full array FF beam with ULA Ntx=128; in FIG. 11B (case B), Primary RS corresponds to a full-array NF beam and secondary RS corresponds to a full array-FF beam with ULA Ntx=128. In FIG. 11 (a), when the WTRU is close to the transmit antenna array, the RSRP of the primary RS outperforms the RSRP of the secondary RS. Therefore, the WTRU is able to detect whether it is close to transmitter or farther away from the transmitter. In FIG. 11 (b), when the WTRU is close to the transmit antenna array, the RSRP of primary RS outperforms the RSRP of secondary RS. Therefore, the WTRU is able to detect whether it is close to transmitter or farther away from the transmitter.

According to an embodiment, a WTRU may use filtered measurement metric, e.g., filtered RSRP or SINR for FF/NF region detection. In case more than one RS groups are configured and used by WTRU for NF region detection, a WTRU may calculate a filtered metric for NF region detection as a function of the calculated metrics in different RS groups (e.g., based on maximum/average/minimum calculated metric) or select one RS group and use its corresponding metric for NF region detection. For example, a WTRU may detect a NF region in case of using the filtered metric (e.g., based on average/minimum criteria) being above a configured threshold(s).

Like other NR RRC measurement events, e.g. NR RRC event categories such as A1-A6 for intra RAT and B1-B2 for Inter RAT Events, NF/FF region detection, e.g., according to criteria presented herein, can be added into a RRC event because NF/FF region detection occurrence transition, e.g. from entering (in) an NF region to leaving (out) of an NF region, the transition may be slow to be stabilized in time because the measurement results may vary due to mobility like measurement events. Therefore, an NF/FF region detection event may be defined as being an RRC event, e.g., in which case L3 filtering measurement may remove the effect of short-term variations such as caused by WTRU mobility. Although at L1 NF/FF measurements may be collected more often, L3 (e.g. RRC) might filter them at a larger configured periodicity and RRC NF/FF region measurement takes a longer-term view of conditions, and the L3 filtering may thus eliminate unnecessary (undesired, spurious) WTRU triggering and reporting of NF/FF region. The WTRU L3/RRC can collect CH measurement from L1, the report interval can be configured. For instance, the WTRU can be configured with a periodic P-RS and/or S-RS so the WTRU can report periodic L1 measured metric (e.g., RSRP and/or SINR) to L3.

The RRC event for triggering NF/FF region detection can be summarized as follows:
a) a L3 Measurement is defined for NF/FF region occurrence change. The definition includes measurement objects, measurement ID, reporting criteria, measurement event definition and etc.;
b) the WTRU may perform L3 measurement (filtering of L1 measurements) according to the measurement configuration. The WTRU reports L3 measurement according to reporting configurations. Consider the case where event-triggering based reporting is configured. For example, the RRC NF/FF region detection event (e.g., entering a NF/FF region) is triggered when the L3 NF/FF region detection measurement exceeds an event threshold for the serving cell, or the NF/FF region event is triggered if below than a threshold (e.g., leaving a NF/FF region).
   To enhance the reliability of the detection, the WTRU may further select the K-best measurement from RS groups for the determination of the NF/FF region. The K value can be configured in the reporting configuration. For example, the best K measurement can be determined by the difference of the measured RSRP between P-RS and S-RS, e.g. selecting those RS group (e.g. K RS group) having large value of RSRP_{i∈P-RS}-(RSRP_{j∈S-RS}+Threshold). For instance, there are two group {RS 4, RS 6} and {RS 5, RS 8} are selected due to satisfaction of detection criteria. To enhance the detection reliability, only the best RS group (i.e., K=1 in this case) will be selected for determination of NF/FF region. Therefore, WTRU further select the strongest measured result among those RS groups, e.g. from RS group {RS 4, RS 6} and {RS 5, RS 8}, so the strongest result of the RS group {RS4, RS6} selected for the determination of NF/FF region because the result of RSRP₄−(RSRP₆+Threshold) is better than RSRP₅−(RSRP₈+Threshold).

### Determination of NF/FF Region(s)

According to an embodiment, an NF region may be associated with a selected RS group(s). Here, the selected RS group means those RS groups that meet the NF region detection criteria (Note: in practice, those RS groups are configured in the same frequency band). In other words, different selected RS groups may indicate different NF regions and those selected RS groups (e.g. two RS groups {RS 4, RS 6}, {RS 5, RS 8}) which meet the detection criteria (e.g. as shown in FIG. 9) can be used for the determination of NF region. For example, different RS group (e.g., {RS 5, RS 8}) can be associated to a NF region and the other RS group (e.g., {RS 4, RS 6}) can be associated to another NF region.

According to an alternative embodiment, the WTRU may determine the best secondary RS among a set of secondary RS, e.g., with the highest measurement result. The WTRU may select the group comprising the best secondary RS for NF/FF detection.

According to yet another alternative embodiment, the WTRU first determines the best P-RS, e.g., among all P-RSs, based on the P-RS measurement results. Then, the WTRU determines a set of groups that comprise the best P-RS. Finally, the WTRU selects a group from the set of groups with the best secondary RS within the set of groups, based on the secondary RS measurement results.

According to an embodiment, the WTRU may select the group comprising the secondary RS corresponding to a current beam for NF/FF region determination.

In case WTRU is configured with conditional NF/FF region detection, a WTRU may detect NF/FF region using a specific set of RS groups (e.g., one or more RS groups configured for NF/FF region detection). Then, if the WTRU detects an NF region, it uses another set of configured RS groups to determine which NF region is detected, e.g., from multiple NF regions.

NF/FF region detection when the explicit information is signaled in the configuration

When the explicit information (e.g., distance, or Tx power) is configured for a set of RS(s), the WTRU may use the explicit information for the purpose of NF region detection.

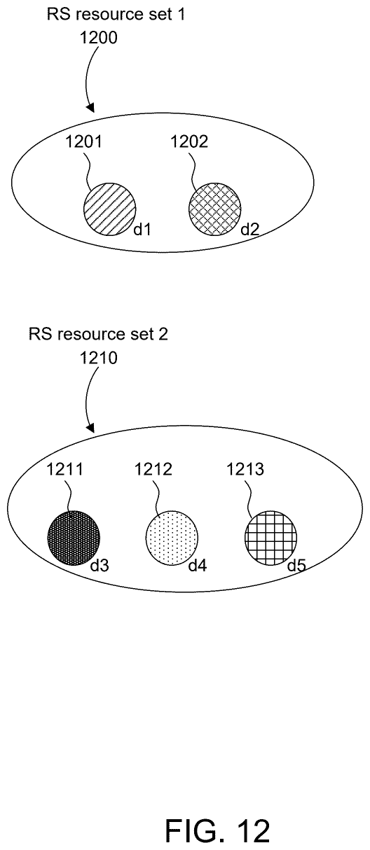

According to an embodiment, for an exemplary configuration, distance information may be associated with an RS, and the distance information corresponds to the spot (focus) beam distance in an RS resource set as shown in FIG. 12. In this FIG., there are two RS resource sets, a first RS resource set 1200 and a second RS resource set 1210. First RS resource set 1200 comprises RS 1 (reference 1201) with associated distance d1 and RS 2 (reference 1202) with associated distance d2. Second RS resource set 1210 comprises RS 3 (reference 1211) with associated distance d3, RS 4 (reference 1212) with associated distance d4 and RS 5 (reference 1213) with associated distance d5. In this case, the (focus) distance (d) can be treated as an explicit information for the spot beam information such that WTRU can use this information to determine or assist the NF/FF region detection. In one embodiment, the WTRU may measure the RSRP or SINR for the RS in the RS resource set and determine which RS has the best results or best K results (i.e., the best K measured RSRP/SINR value) from RS resource sets. Those best K RS(s) may be used to indicate the NF/FF region determination. For example, as shown in FIG. 12, a selected RS (e.g. with best measured RSRP/SINR) (e.g., RS 2) with the configured (associated) distance (e.g. d2) may be used for the indication of an associated NF region if the associated distance is within a region/threshold (note: this region/threshold can be based on a predefined or configured value) then WTRU may declare (may signal, may indicate) that it has detected that it has entered (is in) an NF region.

According to another embodiment, the transmit power of one or more RS can be configured for WTRU as an explicit information in order to help with estimating the distance d. Therefore, WTRU may use the estimated distance for the determination of NF region. For example, an RS in an RS resource set can be configured with a Tx power, and the WTRU can calculate the estimated distance via the difference of configured Tx power and measured Rx power of the RS.

Determination of NF/FF Region(s) when WTRU has the Location Information

If the WTRU has its own location information e.g., from GPS, and the location of gNB/TRP (e.g., location of the gNB/TRP is broadcast by SIB), the WTRU may determine whether it enters a NF/FF region or not. According to an embodiment, the WTRU may determine that it enters/has entered/is in an NF region when a distance that is calculated between the WTRU and gNB/TRP (from a serving cell) is less than a distance threshold or within a range. For example, the distance threshold or range may be signaled/indicated by the NW or may be calculated by the WTRU. If the distance threshold or range is calculated by the WTRU, then the array aperture (D) may be signalled by the NW as well, so that the WTRU may determine the distance threshold

based on a fraction of Rayleigh distance, i.e.,

$$k \frac{2 {D}^{2}}{λ} ,$$

where λ is the wavelength, and k is a fraction number, e.g., k=0.35 (k can be predefined or configured by higher layer). For an exemplary range, the WTRU may calculate a range

$$[ {k}_{1} \frac{2 {D}^{2}}{λ} {k}_{2} \frac{2 {D}^{2}}{λ} ] ,$$

where and k₁ and k₂ are a fraction number, e.g., k₁=0.1, k₂=0.35. If the WTRU calculates that the distance between the WTRU and the serving gNB/TRP is less than the distance threshold or within a range, then the WTRU can detect/determine that it has entered/is entering/is in an NF region, otherwise the WTRU may consider/conclude that it is in an FF region.

### NF/FF Status Report

### Determination to Transmit NF/FF Status Report

According to an embodiment, a WTRU may perform conditional reporting, i.e., WTRU only report NF/FF status when the NF/FF status has changed. According to an embodiment, the WTRU may count a number of instances, e.g., measurement occasions, for which the NF/FF status has changed. If the number of instances is equal to or greater than a configurable number (M, a triggering threshold) within the configured time window, the WTRU may trigger the reporting.

According to an embodiment, the WTRU may include NF/FF status in a CSI or beam management report transmitted by the WTRU, e.g., a network-configured/activated/triggered report or a WTRU-initiated report. The report may comprise measurement results, e.g., RSRP/SINR, for RS(s) in a set of reported RS groups, e.g., for a set of reported secondary RS, or a set of reported primary RS. The WTRU may include a determined NF/FF status for a subset of the reported RS groups, for example an RS group comprising an RS corresponding to a current beam and/or an RS group comprising an RS corresponding to a new beam, such as the RS corresponding to a new beam with the highest reported measurement result.

According to an embodiment, the WTRU may report the FF/NF region status (e.g. in/out) for one or more than one groups from the CSI resource set and secondary CSI resource set, if applicable. The WTRU may also indicate the secondary CSI resource set and/or the associated primary CSI resource set for the corresponding FF/NF region status indication(s).

According to an embodiment, the WTRU may also report a confidence level, e.g., the margin to the threshold.

According to an embodiment, the WTRU may receive an acknowledgment of its reported state. The WTRU may apply the NF or FF configuration after the reception of the acknowledgement.

According to an embodiment, the reported NF/FF region status may be a binary, Boolean, or string value indicating:
a) a change of the propagation field. For instance, WTRU reports 0 in case WTRU determines no change in the propagation field. Alternatively, WTRU reports 1 in case it detects change in the propagation field. NW can infer the current WTRU propagation region based on the latest region status and the reported NF/FF region status from WTRU;
b) the WTRU propagation region. For instance, WTRU reports 0 in case WTRU detects far-field propagation. Alternatively, WTRU reports 1 in case it detects near-field propagation. The NW can determine the current WTRU propagation region directly from the reported NF/FF region status received from the WTRU.

### NF/FF Status Report Details

According to embodiments, reporting of NF/FF region detection/determination may be periodic, aperiodic or conditional. According to embodiments, a WTRU may report the NF/FF region via PUCCH, PRACH (e.g., contention-free PRACH) or PUSCH. According to an embodiment, the NF/FF region feedback (reporting) format may be based on the reporting configuration. For example, the NF/FF region feedback format can be either based on a short or long format. In case of the short NF/FF region feedback format, a WTRU may report NF/FF region status. The WTRU reports the status of detection of NF/FF region. The required number of bits to encode the NF/FF region status information is low, and the information may therefore be carried in a short PUCCH format for optimization, instead of using the long PUCCH format that is able to carry more bits. In this case, when NF/FF region feedback is scheduled, it may be reported using the short PUCCH format. However, due to limited number of available bits for encoding information in the short PUCCH format, if, in case of scheduled higher priority HARQ A/N and SR bit (e.g. format 0/1) is to be transmitted together with the NF/FF region feedback, then transmission of the NF/FF region feedback may be dropped due to it having a lower priority than transmission of HARQ A/N and SR. Similarly, if this NF/FF region feedback cannot joint transmit HARQ A/N, other CSI information (e.g., rank indicator) then NF/FF region feedback can be dropped in long PUCCH format.

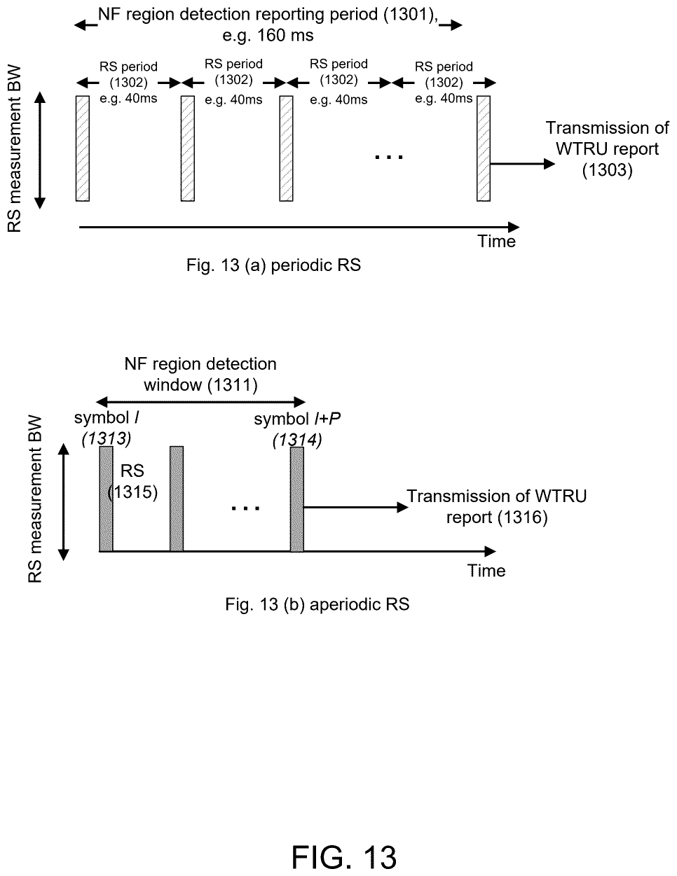

According to an embodiment, a WTRU may report NF region detection feedback at each configured report period, e.g., at an end of NF/FF region detection measurement window. An exemplary periodic RS and NF/FF region detection report is illustrated in FIG. 13 (a) in which a WTRU is configured for transmission of an NF/FF region detection report (reference 1303) every 160 ms (reference 1301) and the configured RS (shown as vertical bars) is with a period of 40 ms (references 1302). An exemplary aperiodic RS and NF region detection report is illustrated in FIG. 13 (b) in which a WTRU may be configured with an aperiodic NF/FF region detection feedback report transmission where the configured RS (1315) may be spanned over a duration or a detection window (1311) (e.g., in terms of number of symbol duration or ms (symbol I (1313) to symbol I+P (1314)) and the WTRU transmits the feedback/report (1316). Timing of the feedback/report transmitting may be configured via signaling, e.g. DCI. In another words, the gNB/network node/network tells the WTRU when to transmit the report via PUSCH after receiving the DCI for triggering the aperiodic reporting.

According to an embodiment, the NF/FF region detection report may carry an identifier which may be associated with one of the RS groups the WTRU selects to perform the corresponding RSRP or SINR measurements. The identifier may be either a group ID which indicated by the gNB or a RS/CSI resource set ID. In addition, if the RS resource set is configured for another cell ID, e.g., when WTRU employs carrier aggregation, then the reporting also includes the cell/carrier ID.

Alternatively, when the WTRU is configured to calculate a certain metric, e.g., SINR/RSRP/RSRQ, for one or more of configured/determined RS groups, the WTRU may be configured to report in which threshold range each calculated metric falls, e.g., by range index. The indices may be reported based on one or more of the following:
a) ascending/descending order of the RS ID in groups (or CRI ID of P-RS, S-RS) on which the corresponding metric is calculated, the selected RS group (e.g. two RS groups {RS 4, RS 6}, {RS 5, RS 8}) which meet the detection criteria. The WTRU may report RS ID in ascending order of RS ID in groups, e.g., {RS 4, RS 6} and {RS 5, RS 8};
b) ascending/descending order of secondary RS ID (or CRI ID of P-RS, S-RS) based on which the corresponding metric is calculated;
c) ascending/descending order of primary RS ID based on which the corresponding metric is calculated.

The NW may then detect whether WTRU is in the NF or FF region based on the reported indices and indicates this to the WTRU.

According to an embodiment, e.g., when the report is included in a MAC CE, the report may comprise one or more NF/FF region statuses corresponding to one or more groups of primary/secondary RS groups and/or one or more primary/secondary resource set pairs. The transmission of the MAC CE may be triggered by one or more lower layer indication(s) of NF/FF region status. The MAC CE may comprise NF/FF region status for one or more serving cells.

### NF Status Acknowledgement and WTRU Action

### NF/FF Status Acknowledgement: Content of the NF/FF Status Acknowledgement

According to an embodiment, a WTRU receives indication from the gNB/NW for NF/FF status acknowledgement. The indication can be one or more of the following:
a) one or more of ACK/NACK bits. The NW confirms/rejects the NF/FF status or status change that the WTRU has reported or recommended. For example, when ACK is received by the WTRU, the WTRU changes its status from NF to FF or from FF to NF based on its previous (currently recorded/stored) NF/FF status. When NACK is received, the WTRU remains in its previous (currently recorded/stored) NF/FF status without applying a status change. The other possible realization is that ACK received by the WTRU which indicates the status is not changed is and NACK received by the WTRU which the status has changed.

According to an embodiment, when the WTRU receives an explicit NF/FF status indication from the gNB/NW, the WTRU applies that status.

### Signaling of the NF/FF Status Acknowledgement

According to embodiments, NF/FF status acknowledgement may be signaled by the gNB through one of or any combination of RRC, MAC-CE and DCI.

### WTRU Action Upon NF/FF Status Change

According to an embodiment, as an action upon NF/FF status change, when the WTRU reports its determined NF/FF region/status, the WTRU may also include, in the report, at least one of the measurements related to the detected state. Further as an action upon an NF/FF status change, the WTRU may perform reporting, if the WTRU has been configured for conditional reporting upon NF/FF status change.

According to an embodiment, a WTRU may report the NF/FF region status (e.g. in/out), one or more than one groups from the CSI resource set and secondary CSI resource set, if applicable. A WTRU may also indicate the associated CSI resource set and secondary (CSI) resource set for each the corresponding FF/NF region status indication.

According to an embodiment, when the WTRU receives an acknowledgment of its reported state, the WTRU may determine its Rx parameters, e.g. QCL relation (QCL information), spot distance information (if available), and perform Rx beamforming based on the detected NF or FF state and the determined Rx parameters.

According to an embodiment, the WTRU may use the 2nd configuration (or apply/activate) upon the change in the detected state (from NF to FF or vice-versa), for e.g., apply/activate relevant codebook(s) associated with the detected state and/or the WTRU may apply the NF or FF measurement configuration according to the detection status, etc. Note that 1st configuration refers to RS resource configurations used for NF/FF region detection, while 2nd configuration refers to configurations used for NF or FF Tx or Rx like codebook, etc.

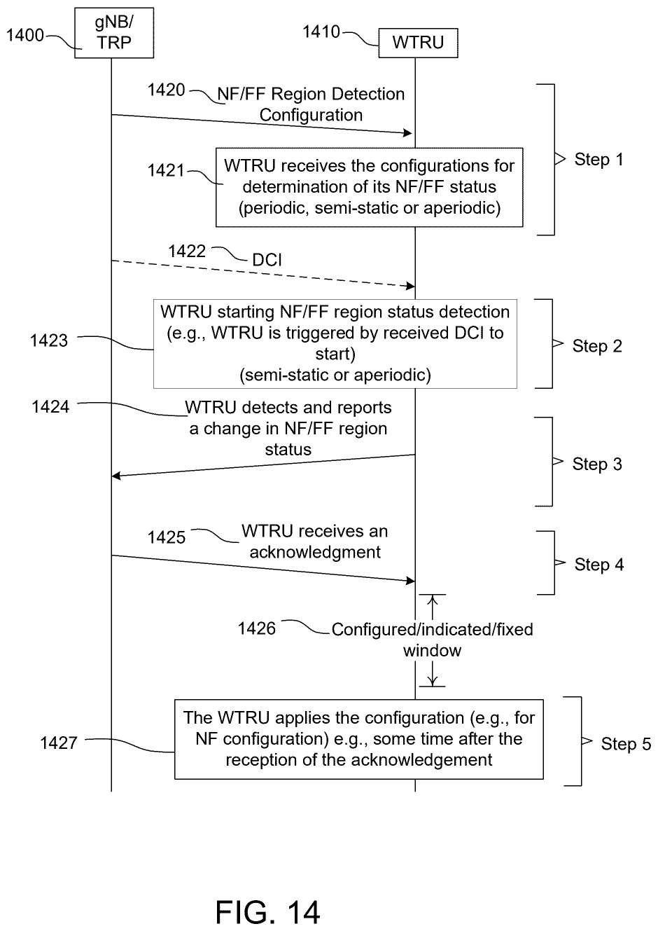

FIG. 14 is a WTRU method for NF/FF region detection.

In a first step (references 1420, 1421), a WTRU (reference 1410) is configured by the network/gNB/TRP (reference 1400) with multiple CSI resources/RS resources for NF/FF region detection, including conditional triggering for measurement reporting.

In a second step (1422, 1423), the WTRU may perform NF/FF detection based on measurement metrics e.g., RSRP/RSRQ/SINR with the associated/assisted RS information such as distance/location, spot beam indication and or Tx power of the RS being configured/signaled for the measured RS:
a) the WTRU may use the associated RS information like distance or location to determine whether enters a NF region or not;
b) the WTRU may use the Tx power of the RS to estimate the distance and use the estimated distance to determine whether entering a NF region.

In a third step (1424), the WTRU may report the detection of the NF/FF region status e.g., RS ID (e.g. CRI), differential RSRP/RSRQ/SINR, through periodic reporting, semi-persistent or aperiodic reporting (e.g. by conditional triggering), conditional reporting, etc.

In a fourth step (1425), the WTRU may receive an ACK of the reported status change from the gNB/NW.

In a fifth step (1427), the WTRU may adjust the appropriate configuration and/or Rx parameters according to the confirmed status, some time (1426) (i.e., a configured time) after the receipt of the acknowledgement.

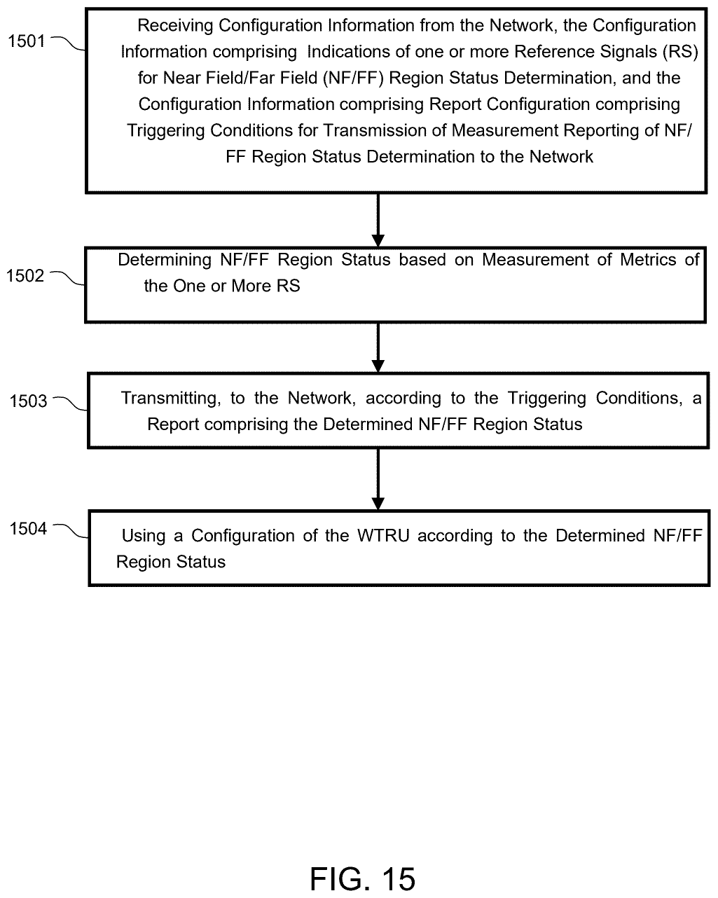

FIG. 15 is a flow chart of a method, implemented by a WTRU in a wireless communication network (a network), according to an embodiment. The method comprises: In 1501, receiving configuration information from the network (e.g., from a (serving) network node, (serving) gNB, (serving) TRP), the configuration information comprising indications of one or more reference signals (RS) for near field/far field (NF/FF) region status determination, and the configuration information comprising report configuration comprising triggering conditions for transmission of measurement reporting of NF/FF region status determination to the network; In 1502, determining NF/FF region status (e.g., in/entered NF region, out/left NF region, in/entered NF region, in/entered FF region, out/left FF region, in between (in both) NF/FF regions) based on measurement of metrics of the one or more RS (measurement of metrics performed on the one or more RS);

In 1503, transmitting, to the network (e.g., to a (serving) network node, a (serving) gNB, a (serving) TRP), according to the triggering conditions, a report comprising the determined NF/FF region status; and

In 1504, using a configuration (configuring) of the WTRU according to the determined NF/FF region status.

According to an embodiment of the method, (each of/some of) the one or more RS comprise a secondary RS set and an associated primary RS set, and the determining the NF/FF region status comprises measuring the metrics on selected primary and secondary RS sets, and using, for the measuring, a same WTRU Rx beam for all of the selected primary and secondary RS sets.

According to an embodiment of the method, based on results of the measuring, the method comprises selecting one or more RS groups, where an RS group comprises a secondary RS and an associated primary RS, and for each of the one or more selected RS groups, determining whether a measurement condition from the received configuration information is fulfilled; and the determining the NF/FF region status is based on measurement of metrics of the one or more RS comprises determining the NF/FF region status based on measurement of metrics for the selected one or more RS groups.

According to an embodiment of the method, the selecting one or more RS groups comprises selecting an RS group of the one or more RS groups with a highest measured metric among the one or more RS groups.

According to an embodiment of the method, the triggering conditions for transmitting the report are fulfilled if the NF/FF region status of at least one of the selected one or more RS groups has changed regarding an NF/FF region status comprised in a previously (previous) transmitted report.

According to an embodiment of the method, the triggering conditions for transmitting the report are fulfilled if the received configuration information comprises triggering conditions for aperiodic or periodic reporting and if the triggering conditions for aperiodic respectively for periodic reporting are satisfied.

According to an embodiment of the method, the configuration information comprises associated RS information per the one or more RS, and the determining the NF/FF region status comprises using the associated RS information, the associated RS information comprising at least one of the following:

an indication of locations of spot beams of a transmission point transmitting the one or more RS; and
an indication of transmission power of a transmission point transmitting the one or more RS.

According to an embodiment of the method, the method comprises using the indication of the transmission power to obtain an estimated distance of the WTRU to the transmission point.

According to an embodiment of the method, using the configuration of (configuring) the WTRU according to the determined NF/FF region status comprises use (switch to the use of, enable) of a procedure for acquisition of channel state information (CSI) using an NF (NF-specific) codebook, if it is determined that the WTRU is in/entered an NF region.

According to an embodiment, the one or more RS are at least one of:
channel state information reference signal (CSI-RS) resources; or
reference signal (RS) resources.

According to an embodiment, the metrics comprise at least one of the following:
reference signal received power (RSRP);
reference signal received quality (RSRQ); and signal-to-interference and noise ratio (SINR).

There is also disclosed and described a wireless transmit-receive unit (WTRU) in a wireless communication network (a network). The WTRU comprises at least one processor configured to:
receive configuration information from the network, the configuration information comprising indications of one or more reference signals (RS) for near field/far field (NF/FF) region status determination, and the configuration information comprising report configuration comprising triggering conditions for transmission of measurement reporting of NF/FF region status determination to the network;
determine NF/FF region status based on measurement of metrics of the one or more RS;
transmit, to the network, according to the triggering conditions, a report comprising the determined NF/FF region status; and
use a configuration of (configure) the WTRU according to the determined NF/FF region status.

According to an embodiment of the WTRU, each (one or more) of the one or more RS comprises a secondary RS set and an associated primary RS set and wherein determine the NF/FF region status comprises measuring the metrics on selected primary and secondary RS sets, and wherein the at least one processor is configured to use, for the measuring, a same WTRU Rx beam for (all of) the selected primary and secondary RS sets.

According to an embodiment of the WTRU, the at least one processor is configured to select, based on results of the measuring, one or more RS groups, where an RS group comprises a secondary RS and an associated primary RS, and for each of the one or more selected RS groups, determine whether a measurement condition from the received configuration information is fulfilled; and wherein determine the NF/FF region status based on measurement of metrics of the one or more RS comprises determine the NF/FF region status based on measurement of metrics for the selected one or more RS groups.

According to an embodiment of the WTRU, the selecting one or more RS groups comprises selecting an RS group of the one or more RS groups with a highest measured metric among the one or more RS groups.

According to an embodiment of the WTRU, the triggering conditions for transmitting the report are fulfilled if the NF/FF region status of at least one of the selected one or more RS groups has changed regarding a NF/FF region status comprised in a previous transmitted report.

According to an embodiment of the WTRU, the triggering conditions for transmitting the report are fulfilled if the configuration information comprises triggering conditions for aperiodic or periodic reporting and if the triggering conditions for aperiodic respectively for periodic reporting are satisfied.

According to an embodiment of the WTRU, the configuration information comprises associated RS information per the one or more RS, wherein the determine the NF/FF region status comprises using the associated RS information, the associated RS information comprising at least one of the following:
an indication of (information of/related to) locations (e.g., (GPS) coordinates) of spot beams of a transmission point transmitting the one or more RS; and
an indication of (information of/related to) transmission power (e.g., in dBm at the transmission point proximity) of a transmission point transmitting the one or more RS.

According to an embodiment of the WTRU, the at least one processor is configured to use the indication of the transmission power to obtain an estimated distance of the WTRU to the transmission point.

According to an embodiment of the WTRU, using a configuration of (configuring) the WTRU according to the determined NF/FF region status comprises enabling (switching to) a procedure for acquisition of channel state information (CSI) using a (specific) NF codebook, if it is determined that the WTRU entered an NF region.

According to an embodiment of the WTRU, the one or more RS are at least one of:
channel state information reference signal (CSI-RS) resources; and
reference signal (RS) resources.

According to an embodiment of the WTRU, the metrics comprise at least one of the following:
reference signal received power;
reference signal received quality; and
signal-to-interference and noise ratio.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112. ¶6 or means-plus-function claim format, and any claim without the terms “means for” is not so intended.

What is claimed is:

1. A method, implemented by a wireless receive-transmit unit (WTRU) in a wireless communication network, the method comprising:
receiving configuration information from the network, the configuration information comprising indications of one or more reference signals (RS) for near field/far field (NF/FF) region status determination, and the configuration information comprising report configuration comprising triggering conditions for transmission of measurement reporting of NF/FF region status determination to the network;
determining NF/FF region status based on measurement of metrics of the one or more RS;
transmitting, to the network, according to the triggering conditions, a report comprising the determined NF/FF region status; and
using a configuration of the WTRU according to the determined NF/FF region status.

2. The method of claim 1, wherein each of the one or more RS comprises a secondary RS set and an associated primary RS set, and wherein the determining the NF/FF region status comprises measuring the metrics on selected primary and secondary RS sets, and using, for the measuring, a same WTRU Rx beam for all of the selected primary and secondary RS sets.

3. The method of claim 2, comprising,
based on results of the measuring, selecting one or more RS groups, where an RS group comprises a secondary RS and an associated primary RS, and for each of the one or more selected RS groups, determining whether a measurement condition from the received configuration information is fulfilled; and
wherein the determining NF/FF region status based on measurement of metrics of the one or more RS comprises determining the NF/FF region status based on measurement of metrics for the selected one or more RS groups.

4. The method of claim 3, wherein the selecting one or more RS groups comprises selecting an RS group of the one or more RS groups with a highest measured metric among the one or more RS groups.

5. The method of claim 3, wherein the triggering conditions for transmitting the report are fulfilled if the NF/FF region status of at least one of the selected one or more RS groups has changed regarding an NF/FF region status comprised in a previous transmitted report.

6. The method of claim 1, wherein the triggering conditions for transmitting the report are fulfilled if the received configuration information comprises triggering conditions for aperiodic or periodic reporting and if the triggering conditions for aperiodic respectively for periodic reporting are satisfied.

7. The method of claim 1, wherein the configuration information comprises associated RS information per the one or more RS, wherein the determining the NF/FF region status comprises using the associated RS information, the associated RS information comprising at least one of the following:
an indication of locations of spot beams of a transmission point transmitting the one or more RS; and
an indication of a transmission power of a transmission point transmitting the one or more RS.

8. The method of claim 7, comprising using the indication of the transmission power to obtain an estimated distance of the WTRU to the transmission point.

9. The method of claim 1, wherein when using a configuration of the WTRU according to the determined NF/FF region status, the WTRU enables a procedure for acquisition of channel state information (CSI) using an NF codebook, if it is determined that the WTRU entered an NF region.

10. The method of claim 1, wherein the one or more RS are at least one of:
channel state information reference signal (CSI-RS) resources; or
reference signal (RS) resources.

11. The method of claim 1, wherein the metrics comprise at least one of the following:
reference signal received power;
reference signal received quality; and
signal-to-interference and noise ratio.

12. A wireless transmit-receive unit (WTRU) in a wireless communication network, wherein the WTRU comprises at least one processor configured to:
receive configuration information from the network, the configuration information comprising indications of one or more reference signals (RS) for near field/far field (NF/FF) region status determination, and the configuration information comprising report configuration comprising triggering conditions for transmission of measurement reporting of NF/FF region status determination to the network;
determine NF/FF region status based on measurement of metrics of the one or more RS;
transmit, to the network, according to the triggering conditions, a report comprising the determined NF/FF region status; and
use a configuration of the WTRU according to the determined NF/FF region status.

13. The WTRU of claim 12, wherein each of the one or more RS comprises a secondary RS set and an associated primary RS set and wherein determine the NF/FF region status comprises measuring the metrics on selected primary and secondary RS sets, and wherein the at least one processor is configured to use, for the measuring, a same WTRU Rx beam for all of the selected primary and secondary RS sets.

14. The WTRU of claim 13, wherein the at least one processor is configured to select, based on results of the measuring, one or more RS groups, where an RS group comprises a secondary RS and an associated primary RS, and for each of the one or more selected RS groups, determine whether a measurement condition from the received configuration information is fulfilled; and
wherein determine NF/FF region status based on measurement of metrics of the one or more RS comprises determine the NF/FF region status based on measurement of metrics for the selected one or more RS groups.

15. The WTRU according to claim 14, wherein the selecting one or more RS groups comprises selecting an RS group of the one or more RS groups with a highest measured metric among the one or more RS groups.

16. The WTRU according to claim 14, wherein the triggering conditions for transmitting the report are fulfilled if the NF/FF region status of at least one of the selected one or more RS groups has changed regarding a NF/FF region status comprised in a previous transmitted report.

17. The WTRU according to claim 12, wherein the triggering conditions for transmitting the report are fulfilled if the configuration information comprises triggering conditions for aperiodic or periodic reporting and if the triggering conditions for aperiodic respectively for periodic reporting are satisfied.

18. The WTRU according to claim 12, wherein the configuration information comprises associated RS information per the one or more RS, wherein the determine the NF/FF region status comprises using the associated RS information, the associated RS information comprising at least one of the following:
an indication of locations of spot beams of a transmission point transmitting the one or more RS; and
an indication of a transmission power of a transmission point transmitting the one or more RS.

19. The WTRU according to claim 18, wherein the at least one processor is configured to use the indication of the transmission power to obtain an estimated distance of the WTRU to the transmission point.

20. The WTRU of claim 12, wherein the at least one processor is configured to, when using a configuration of the WTRU according to the determined NF/FF region status, enable a procedure for acquisition of channel state information (CSI) using an NF codebook, if it is determined that the WTRU entered an NF region.

21. The WTRU of the claim 12, wherein the one or more RS are at least one of:
channel state information reference signal (CSI-RS) resources; or
reference signal (RS) resources.

22. The WTRU of claim 12, wherein the metrics comprise at least one of the following:
reference signal received power:
reference signal received quality; and
signal-to-interference and noise ratio.
